(19) United States
(12) Patent Application Publication
(10) Pub. No.: US 2025/0022317 A1
(43) Pub. Date: Jan. 16, 2025

(54) REPETITION COUNTING WITHIN CONNECTED FITNESS SYSTEMS

(71) Applicant: Peloton Interactive, Inc., New York, NY (US)

(72) Inventors: Darren Kitamura, Mississauga (CA); Andrew Glose, Alameda, CA (US); Michelle Hessel, New York, NY (US); Sandra Atakora, New York, NY (US); Jon Cilley, New York, NY (US)

(21) Appl. No.: 18/771,557

(22) Filed: Jul. 12, 2024

Related U.S. Application Data
(63) Continuation-in-part of application No. PCT/US23/74615, filed on Sep. 19, 2023.
(60) Provisional application No. 63/513,466, filed on Jul. 13, 2023.

(51) Int. Cl. G06V 40/20; G06T 7/20; G06V 10/764; G06V 10/82

(52) U.S. Cl. CPC G06V 40/25; G06T 7/20; G06V 10/764; G06V 10/82; G06T 2207/10004; G06T 2207/10016; G06T 2207/20081; G06T 2207/20084; G06T 2207/30196

(57) ABSTRACT

Various systems and methods that enhance an exercise or other physical activity performed by a user are described. In some embodiments, a repetition counting systems can track, monitor, count, or determine a number of repetitions of movements performed by a user during an exercise activity, such as an interval-based exercise class (e.g., an AMRAP or EMOM). For example, the repetition counting system can utilize classification or matching techniques to determine that a certain number of repetitions of a given movement or exercise are performed by the user during a round or segment, and perform an action for the exercise class.

### CROSS REFERENCE TO RELATED APPLICATIONS

This application claims priority to U.S. Provisional Patent Application No. 63/513,466, filed on Jul. 13, 2023, entitled REPETITION COUNTING WITHIN CONNECTED FITNESS SYSTEMS, which is hereby incorporated by reference in its entirety. Further, this application is a continuation-in-part (CIP) of PCT Application No. PCT/US23/74615, filed on Sep. 19, 2023, entitled REPETITION COUNTING WITHIN CONNECTED FITNESS SYSTEMS, which is hereby incorporated by reference in its entirety.

### BACKGROUND

The world of connected fitness is an ever-expanding one. This world can include a user taking part in an activity (e.g., running, cycling, lifting weights, and so on), other users also performing the activity, and other users doing other activities. The users may be utilizing a fitness machine (e.g., a treadmill, a stationary bike, a strength machine, a stationary rower, and so on), or may be moving through the world on a bicycle.

The users can also be performing other activities that do not include an associated machine, such as running, strength training, yoga, stretching, hiking, climbing, and so on. These users can have a wearable device or mobile device that monitors the activity and may perform the activity in front of a user interface (e.g., a display or device) presenting content associated with the activity.

The user interface, whether a mobile device, a display device, or a display that is part of a machine, can provide or present interactive content to the users. For example, the user interface can present live or recorded classes, video tutorials of activities, leaderboards and other competitive or interactive features, progress indicators (e.g., via time, distance, and other metrics), and so on.

While current connected fitness technologies provide an interactive experience for a user, the experience can often be generic across all or groups of users, or based on a few pieces of information (e.g., speed, resistance, distance traveled) about the users who are performing the activities.

### BRIEF DESCRIPTION OF THE DRAWINGS

Embodiments of the present technology will be described and explained through the use of the accompanying drawings.

FIG. 1 is a block diagram illustrating a suitable network environment for users of an exercise system.

FIG. 2 is a block diagram illustrating a classification system for an exercise platform.

FIG. 3 is a diagram illustrating a neural network for detecting a pose of a user during an activity.

FIGS. 4-6 are diagrams illustrating a bottom-up pose classifier for classifying a pose of a user during an activity.

FIGS. 7A-9 are diagrams illustrating an exercise classification system for classifying an exercise being performed by a user.

FIG. 10 is a diagram illustrating a match-based approach for classifying a pose of a user during an activity.

FIG. 11 is a flow diagram illustrating an example method for determining an exercise performed by a user.

FIG. 12A is a diagram illustrating a pose state machine.

FIG. 12B is a diagram illustrating an exercise verification system using an optical flow technique.

FIG. 12C is a flow diagram illustrating an example method for determining a user is following an exercise class.

FIG. 13A is a diagram illustrating a lock-on technique for targeting a user of an activity.

FIGS. 13B-13C are diagrams illustrating the smart framing of a user during an activity.

FIG. 14 is a flow diagram illustrating an example method for counting repetitions of an exercise performed by a user.

FIG. 15 is a diagram illustrating a multi-task model architecture.

FIG. 16 is a block diagram illustrating a state machine for repetition counting.

FIG. 17 is a block diagram illustrating a state machine for determining orientation.

FIGS. 18A-18B are graphs of example signals generated by keypoint detection techniques.

FIG. 19 is a graph of an example signal for a movement.

FIG. 20 is a flow diagram illustrating an example method for counting repetitions of an exercise performed by a user.

FIG. 21 is a flow diagram illustrating an example method for determining a repetition count of a movement performed by a user.

FIG. 22 is a diagram illustrating components of a repetition counting system.

FIG. 23 is a flow diagram illustrating an example method for counting repetitions of an interval-based segment of an exercise class performed by a user.

FIG. 24 is a diagram illustrating an example user interface displayed during an interval-based exercise class.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### Overview

Various systems and methods that enhance an exercise or other physical activity performed by a user are described. In some embodiments, a repetition counting system can track, monitor, count, or determine a number of repetitions of movements performed by a user during an exercise activity, such as an interval-based exercise activity or segment. For example, the repetition counting system can utilize classification or matching techniques (e.g., machine learning (ML) or artificial intelligence (AI) techniques) to determine that a certain number of repetitions of a given movement or exercise are performed by the user for a given round or segment.

For example, in some embodiments, the repetition counting system can utilize a neural network framework to employ a multi-task machine learning model to perform multiple tasks when counting or determining repetitions of a movement performed by the user. The multi-task model can include prediction heads that generate predictions for the movement being performed by the user (e.g., whether the user is following along), that count the repetitions of the movement (e.g., tracking how many reps a user performs for a given movement), that determine whether a user is in a correct orientation with respect to a camera capturing images or video of the user, and so on.

In some embodiments, the systems and methods can employ repetition counting techniques to determine a user has completed a repetition-based class, workout, segment, or round (e.g., an AMRAP or EMOM round), and perform an action to progress the user to a next segment or round and/or determine the user has successfully, performed the segment or round.

A repetition-based segment or round can be a round having a periodic or interval-based training pattern, where a user completes a certain number of repetitions within a given time (within a minute, 90 seconds, 45 seconds, and so on), rests, and then starts again once the initial segment has ended. In some cases, a class can include rounds with a constant duration (e.g., a class of EMOM segments), or varying durations (a first segment of 45 seconds, followed by a second segment of 60 seconds, followed by a third segment of 45 seconds).

In some embodiments, the systems and methods can combine various repetition counting techniques to enhance accuracy of its predictions and/or utilize a technique that works best for certain movements or conditions. Thus, the systems and methods provide a connected fitness platform with a robust, flexible framework for performing repetition counting and other actions using images or video streams of users performing exercise movements, among other benefits.

Various embodiments of the system and methods will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Exercise Platform

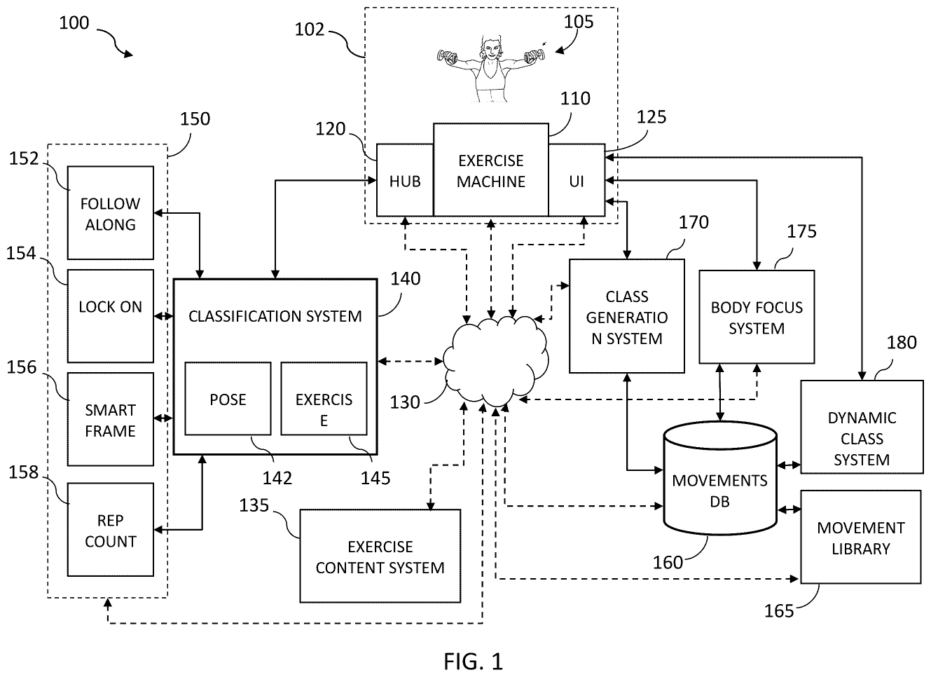

The technology described herein is directed, in some embodiments, to providing a user with an enhanced user experience when performing an exercise or other physical activity, such as an exercise activity as part of a connected fitness system or other exercise system. FIG. 1 is a block diagram illustrating a suitable network environment 100 for users of an exercise system.

The network environment 100 includes an activity environment 102, where a user 105 is performing an exercise activity, such as a strength or lifting activity. In some cases, the user 105 can perform the activity with an exercise machine 110, such as a digital strength machine. An example strength machine can be found in co-pending PCT Application No. PCT/US22/22879, filed on Mar. 31, 2022, entitled CONNECTED FITNESS SYSTEMS AND METHODS, which is hereby incorporated by reference in its entirety.

The exercise activity performed by the user 105 can include a variety of different workouts, activities, actions, and/or movements, such as movements associated with stretching, doing yoga, lifting weights, rowing, running, cycling, jumping, dancing, sports movements (e.g., throwing a ball, pitching a ball, hitting, swinging a racket, swinging a golf club, kicking a ball, hitting a puck), and so on.

The exercise machine 110 can assist or facilitate the user 105 to perform the movements and/or can present interactive content to the user 105 when the user 105 performs the activity. For example, the exercise machine 110 can be a stationary bicycle, a stationary rower, a treadmill, a weight or strength machine, or other machines (e.g., weight stack machines). As another example, the exercise machine 110 can be a display device that presents content (e.g., classes, dynamically changing video, audio, video games, instructional content, and so on) to the user 105 during an activity or workout.

The exercise machine 110 includes a media hub 120 and a user interface 125. The media hub 120, in some cases, captures images and/or video of the user 105, such as images of the user 105 performing different movements, or poses, during an activity. The media hub 120 can include a camera or cameras (e.g., a RGB camera), a camera sensor or sensors, or other optical sensors (e.g., LIDAR or structure light sensors) configured to capture the images or video of the user 105.

In some cases, the media hub 120 can capture audio (e.g., voice commands) from the user 105. The media hub 120 can include a microphone or other audio capture devices, which captures the voice commands spoken by a user during a class or other activity. The media hub 120 can utilize the voice commands to control operation of the class (e.g., pause a class, go back in a class), to facilitate user interactions (e.g., a user can vocally “high five” another user), and so on.

In some cases, the media hub 120 includes components configured to present or display information to the user 105. For example, the media hub 120 can be part of a set-top box or other similar device that outputs signals to a display (e.g., television, laptop, tablet, mobile device, and so on), such as the user interface 125. Thus, the media hub 120 can operate to both capture images of the user 105 during an activity, while also presenting content (e.g., streamed classes, workout statistics, and so on) to the user 105 during the activity. Further details regarding a suitable media hub can be found in U.S. application Ser. No. 17/497,848, filed on Oct. 8, 2021, entitled MEDIA PLATFORM FOR EXERCISE SYSTEMS AND METHODS, which is hereby incorporated by reference in their entirety.

The user interface 125 provides the user 105 with an interactive experience during the activity. For example, the user interface 125 can present user-selectable options that identify live classes available to the user 105, pre-recorded classes available to the user 105, historical activity information for the user 105, progress information for the user 105, instructional or tutorial information for the user 105, and other content (e.g., video, audio, images, text, and so on), that is associated with the user 105 and/or activities performed (or to be performed) by the user 105.

The exercise machine 110, the media hub 120, and/or the user interface 125 can send or receive information over a network 130, such as a wireless network. Thus, in some cases, the user interface 125 is a display device (e.g., attached to the exercise machine 110), that receives content from (and sends information, such as user selections) an exercise content system 135 over the network 130. In other cases, the media hub 120 controls the communication of content to/from the exercise content system 135 over the network 130 and presents the content to the user via the user interface 125.

The exercise content system 135, located at one or more servers remote from the user 105, can include various content libraries (e.g., classes, movements, tutorials, and so on) and perform functions to stream or otherwise send content to the machine 110, the media hub 120, and/or the user interface 125 over the network 130.

In addition to a machine-mounted display, the display device 125, in some embodiments, can be a mobile device associated with the user 105. Thus, when the user 105 is performing activities outside of the activity environment 102 (such as running, climbing, and so on), a mobile device (e.g., smart phone, smart watch, or other wearable device), can present content to the user 105 and/or otherwise provide the interactive experience during the activities.

In some embodiments, a classification system 140 communicates with the media hub 120 to receive images and perform various methods for classifying or detecting poses and/or exercises performed by the user 105 during an activity. The classification system 140 can be remote from the media hub 120 (as shown in FIG. 1) or can be part of the media hub 120 (e.g., contained by the media hub 120).

The classification system 140 can include a pose detection system 142 that detects, identifies, and/or classifies poses performed by the user 105 and depicted in one or more images captured by the media hub 120. Further, the classification system 140 can include an exercise detection system 145 that detects, identifies, and/or classifies exercises or movements performed by the user 105 and depicted in the one or more images captured by the media hub 120.

Various systems, applications, and/or user services 150 provided to the user 105 can utilize or implement the output of the classification system 140, such as pose and/or exercise classification information. For example, a follow along system 152 can utilize the classification information to determine whether the user 105 is “following along” or otherwise performing an activity being presented to the user 105 (e.g., via the user interface 125).

As another example, a lock on system 154 can utilize the person detection information and the classification information to determine which user, in a group of users, to follow or track during an activity. The lock on system 154 can identify certain gestures performed by the user and classified by the classification system 140 when determining or selecting the user to track or monitor during the activity.

Further, a smart framing system 156, which tracks the movement of the user 105 and maintains the user in a certain frame over time, can utilize the person detection information when tracking and/or framing the user.

Also, a repetition counting system 158 (e.g., “rep counting system”) can utilize the classification or matching techniques to count, track, or otherwise determine repetitions of a given movement or exercise (e.g., within an interval or segment) are performed by the user 105 during a class, another presented experience, or when the user 105 is performing an activity without participation in a class or experience.

Of course, other systems can also utilize pose or exercise classification information when tracking users and/or analyzing user movements or activities. Further details regarding the classification system 140 and various systems (e.g., the follow along system 152, the lock on system 154, the smart framing system 156, the repetition counting system 158, and so on) are described herein.

In some embodiments, the systems and methods include a movements database (dB) 160. The movements database 160, which can reside on a content management system (CMS) or other system associated with the exercise platform (e.g., the exercise content system 135), can be a data structure that stores information as entries that relate individual movements to data associated with the individual movements. As is described herein, a movement is a unit of a workout or activity, and in some cases, the smallest unit of the workout or activity (e.g., an atomic unit for a workout or activity). Example movements include a push-up, a jumping jack, a bicep curl, an overhead press, a yoga pose, a dance step, a stretch, and so on.

The movements database 160 can include, or be associated with, a movement library 165. The movement library 165 includes short videos (e.g., GIFs) and long videos (e.g., ˜90 seconds or longer) of movements, exercises, activities, and so on. Thus, in one example, the movements database 160 can relate a movement to a video or GIF within the movement library 165.

In some embodiments, the movements database 160 includes various entries that relate a movement to metadata and other information, such as information associated with presenting content to users, filtering content, creating enhanced or immersive workout experiences, and so on.

Each entry includes various information stored with and related to a given movement. For example, the movements database 160 can store, track, or relate various types of metadata, such as movement name or identification information and movement context information. The context information can include, for each movement:
skill level information that identifies an associated skill level for the movement (e.g., easy, medium, hard, and so on);
movement description information that identifies or describes the movement and how to perform the movement;
equipment information that identifies exercise machines (e.g., a rowing machine) and/or other equipment (e.g., mats, bands, weights, boxes, benches, and so on) to utilize when performing the movement;
body focus information (e.g., arms, legs, back, chest, core, glutes, shoulders, full body, and so on) that identifies a body part or parts targeted during the movement;
muscle group information (e.g., biceps, calves, chest, core, forearms, glutes, hamstrings, hips, lats, lower back, mid back, obliques, quads, shoulders, traps, triceps, and so on) that identifies a primary, secondary, and/or tertiary muscle group targeted during the movement; and so on.

The movements database 160 can also store or contain ML movement identifier information. The ML movement identifier information can link or relate to a body tracking algorithm, such as the various algorithms described herein with respect to tracking, identifying, and/or classifying poses, exercises, and other activities. Further, the movements database 160 can store related movement information identifying movement variations, as well as related movements, movement modifications, movements in a similar exercise progression, compound movements that include the movement, and so on.

The movements database 160 can also track related content information, such as videos or images associated with the movement. For example, the movements database 160, as described herein, is associated with the movement library 165. The movement library 165 includes or stores short videos (e.g., GIFs) and long videos (e.g., ˜90 seconds or longer) of movements, exercises, activities, and so on. Thus, the movements database 160 can store the video library information as the content information, and track or maintain a relationship between a movement and a video or GIF within the movement library 165. Of course, the movements database 160 can store information, such as other metadata, not explicitly described herein.

Thus, the movements database 160 can store metadata and other information for various movements that act as building blocks or units of class segments and classes. Virtually any pose or action can be a movement, and movements can be units of a variety of different activities, such as strength-based activities, yoga-based or stretching-based activities, sports-based activities, and so on.

Various systems and applications can utilize information stored by the movements database 160. For example, a class generation system 170 can utilize information from the movements database 160 when generating, selecting, and/or recommending classes for the user 105, such as classes that target specific muscle groups.

As another example, a body focus system 175 can utilize information stored by the movements database 160 when presenting information to the user 105 that identifies how a certain class or activity strengthens or works the muscles of their body. The body focus system 175 can present interactive content that highlights certain muscle groups, displays changes to muscle groups over time, tracks the progress of the user 105, and so on.

Further, a dynamic class system 180 can utilize information stored by the movements database 160 when dynamically generating a class or classes (or generating one or more class recommendations) for the user 105. For example, the dynamic class system 180 can access information for the user 105 from the body focus system 175 and determine one or more muscles to target in a new class for the user 105. The system 180 can access the movements database 160 using movements associated with the targeted muscles and dynamically generate a new class (or recommend one or more existing classes) for the user that incorporates videos and other content identified by the database 160 as being associated with the movements.

Of course, other systems or user services can utilize information stored in the movements database 160 when generating, selecting, or otherwise providing content to the user 105. Further details regarding the movements database 160 and various systems (e.g., the class generation system 170, the body focus system 175, the dynamic class system 180, and so on) will be described herein.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network or cloud 130 can be any network, ranging from a wired or wireless local area network (LAN), to a wired or wireless wide area network (WAN), to the Internet or some other public or private network, to a cellular (e.g., 4G, LTE, or 5G network), and so on. While the connections between the various devices and the network 130 and are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of the Classification System and Associated Systems

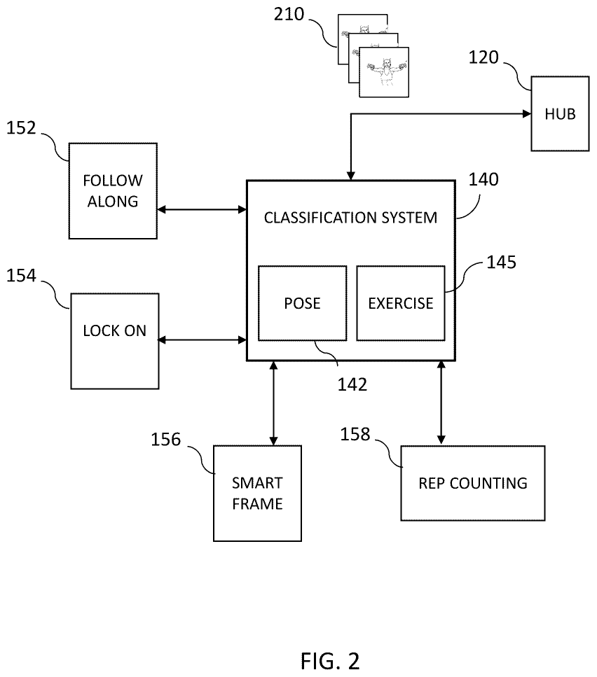

As described herein, in some embodiments, the classification system 140 communicates with the media hub 120 to receive images and perform various method for classifying or detecting poses and/or exercises performed by the user 105 during an activity. FIG. 2 depicts interactions between the classification system 140 and other systems or devices of an exercise platform or connected fitness environment.

The classification system 140 receives images 210 from the media hub 120. The images 210 depict the user 105 in various poses, movements, or exercises during an activity. For example, the poses can include standing poses, sitting poses, squatting poses, arms extended, arms overhead, yoga poses, cycling poses, running poses, rowing poses, strength poses, sports poses, dance poses, and so on. Similarly, the exercises can include standing exercises, sitting exercises, squatting exercises, strength exercises (e.g., lifting movements with arms extended, arms overhead, and so on), yoga exercises, cycling exercises, running exercises, rowing exercises, sports exercises (e.g., throwing or kicking movements, and so on. The exercises can include one or more movements, such as a single movement or a combination of movements.

Further, the poses or exercises can include non-activity movements (or movements not associated with the activity), such as poses or movements associated with a user resting (e.g., sitting or leaning), walking, drinking water, or otherwise non engaged with the activity (e.g., talking a short break or rest).

The classification system 140, using the images 210, can perform various techniques, such as machine learning (ML) or computer vision (CV) techniques, for detecting and/or classifying a pose, movement, or an exercise from an image or set of images. The system 140 can perform these techniques separately, or combine various techniques to achieve certain results, such as results that classify poses and provide accurate inferences or predictions to other systems, such as the follow along system 152 and/or the repetition counting system 158. The following frameworks illustrate operations performed by the classification system 140 when detecting and/or classifying poses, movements, or exercises within images captured by the system.

### Examples of Pose Classification Frameworks

As described herein, the classification system 140 includes the pose detection system 142, which detects, identifies, and/or classifies poses performed by the user 105 that are depicted in the images 210 captured by the media hub 120.

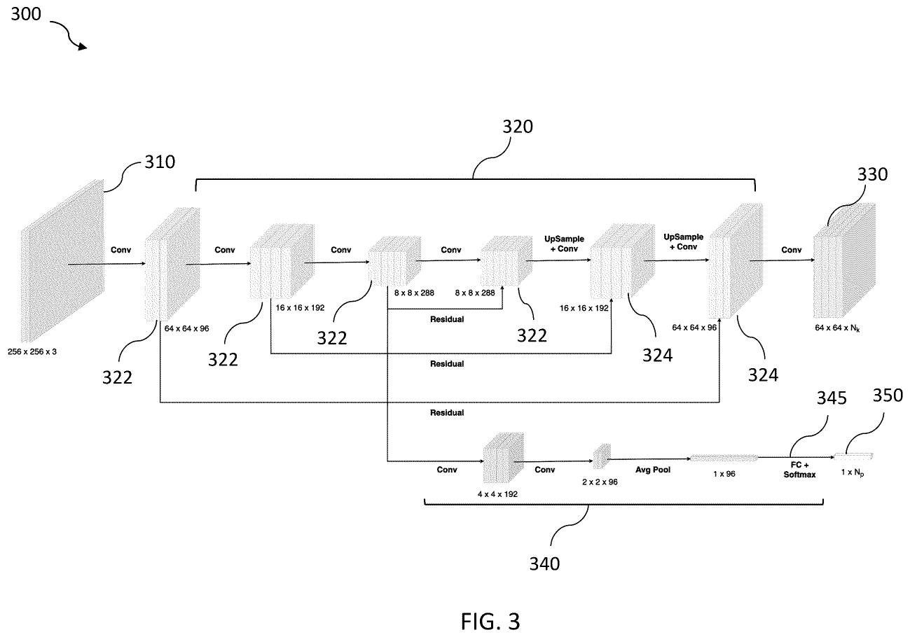

The pose detection system 142, in some embodiments, employs a DeepPose classification technique. FIG. 3 is a diagram illustrating a neural network 300 for detecting a pose of a user during an activity. DeepPose is a deep neural network that extends a top-down keypoint detector for pose classification, and thus performs both keypoint detection and pose classification.

The neural network 300 receives an image 310 and utilizes a U-Net style keypoint detector 320 (or other convolutional neural network), which processes a crop of the user 105 in the image 310 through a series of downsampling or encoding layers 322 and upsampling or decoding layers 324 to predict a keypoint heatmap 330, or feature map, for the image 310. The keypoint detector 320, in some cases, identifies keypoints, or interest points, of a user with the image 310.

Additional DeepPose layers 340 receive the feature map 330 generated by the keypoint detector 320 (at the end of the downsampling layers), perform additional downsampling, and pass the feature map 330 through a fully connected layer 345 with Softmax (e.g., a function that converts a vector of numbers into a vector of probabilities), which detects and classifies the pose depicted in the image 310, providing a classification 350 of the pose within the image 310. In some cases, the classification system 142 performs a series of photometric, translational, rotational, and/or mirroring augmentations on the input images 310 to ensure the neural network 300 is robust.

In some embodiments, the pose detection system 142 employs a bottom-up pose classifier, such as a CenterPose classification technique. The CenterPose classification technique is based on an object detector framework, such as the CenterNet framework, which is a bounding box-based detector that operates to identify objects as axis-aligned boxes in an image.

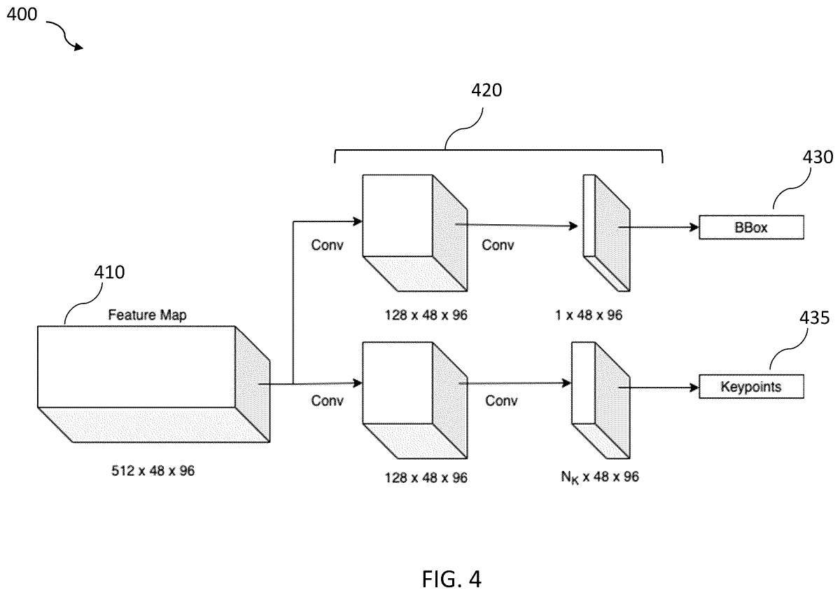

FIGS. 4-6 are diagrams illustrating a bottom-up pose classifier for classifying a pose of a user during an activity. The bottom-up classifier can perform simultaneous person detection, keypoint detection, and pose classification.

FIG. 4 depicts the underlying object detection architecture, model, or framework 400. The framework 400 receives an image, or feature map 410, as input. Various downsampling or encoding layers 420 convert the feature map 410, resulting in two downsampled heatmaps, a BBox (bounding box) heatmap 430 and a Keypoints heatmap 435. The BBox heatmap 430 includes peaks that correspond to the center of each person in the image, and the Keypoints heatmap 435 includes channel-wise peaks to the center of each keypoint. In some cases, the framework 400 includes additional regression heads (not shown) that can predict the width and height of the person box and keypoint offsets of the heatmaps 430, 435.

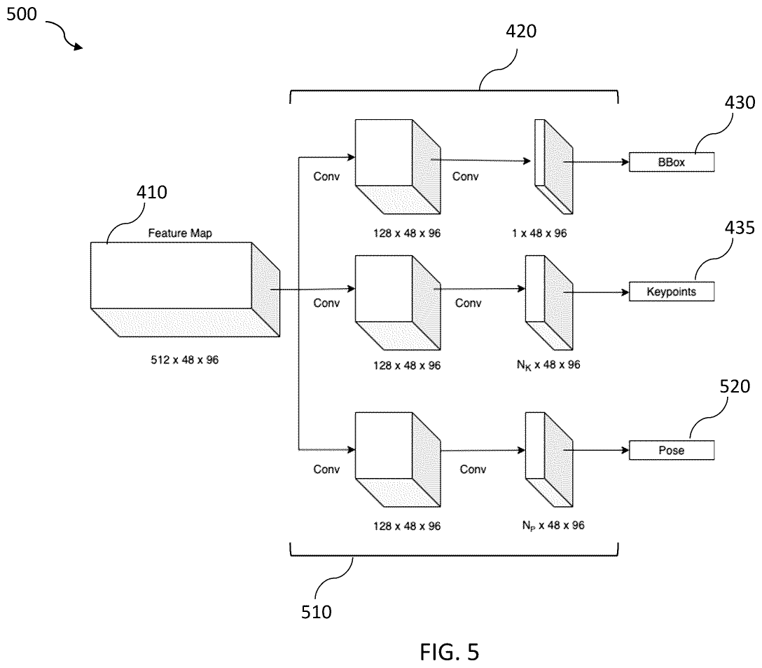

FIG. 5 depicts a model or framework 500 that includes the addition of an additional head 510 to the framework 400 of FIG. 4. The additional head 510 generates, via additional downsampling or encoding layers, a pose heatmap 520 having channel-wise peaks that correspond to a pose the user 105 is currently performing (depicted in the feature map 410 of the image).

The pose heatmap 520 can have dimensions N_{P}×48×96, where N_{P} is a set of available poses to be classified (e.g., the set of all available or possible poses). While the other heads can use a Sigmoid (e.g., squashing function), the head 510 can utilize a Softmax function or layer (as described herein), in order to identify only one pose for each localized user. In some cases, when the peaks of the pose and user (or person) heatmaps do not exactly align, the framework 500 can associate each pose peak with a closest person, or use, peak.

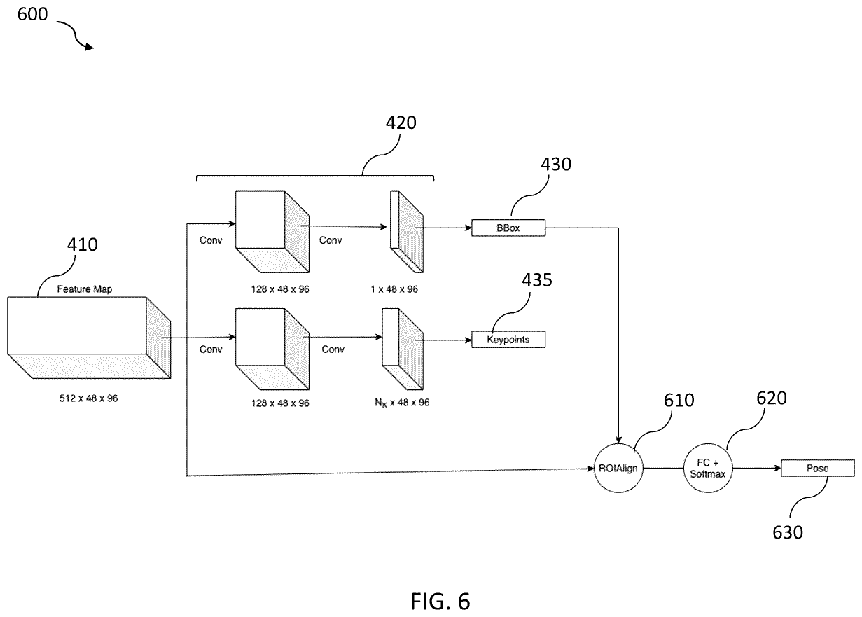

FIG. 6 depicts a model or framework 600 that includes an ROIAlign (Region of Interest Align) operation to extract a small feature map from the BBox heatmap 430. The framework 600 utilizes a ROIAlign operation 610 with the person bounding boxes (BBox heatmap 430) on the image feature map to create person-localized feature maps, which are provided to additional downsampling and Fully Connected+Softmax layers 620 to predict or output a pose or pose heatmap 630.

In addition to the frameworks 500 and 600, the pose classification system 142 can utilize other classification techniques. For example, the system 142 can employ classical classifiers, like XGBoost, on keypoints from a keypoint detector to classify poses within images. In some cases, the system 142 can normalize the keypoint coordinates by the frame dimensions to be in the 0-1 range before passing them to the classifier for classification.

In some cases, the pose classification system 142 can perform hierarchical classification of poses. For example, poses can have multiple variations (e.g., a pose of “Bicep Curl” can be done either sitting, standing, or kneeling, and either just on the left side, just right, or alternating). The frameworks 500, 600 can model or learn these variational relationships by incorporating a hierarchy of poses in the model training loss, where pose predictions that are closer to a ground truth in the hierarchy are penalized less than those further away.

### Examples of Exercise Classification Frameworks

As described herein, the classification system 140 includes the exercise detection system 145, which detects, identifies, and/or classifies exercises performed by the user 105 that are depicted in the images 210 captured by the media hub 120.

The exercise detection system 145, in some embodiments, employs a set of action recognition techniques to identify an exercise that a person (e.g., the user 105) is performing within a set of images or video stream, such as the images 210. The action recognition techniques can be called “DeepMove,” and utilize various ML/CV models or frameworks, such as the neural network framework 300 of FIG. 3, which utilizes keypoint detection techniques.

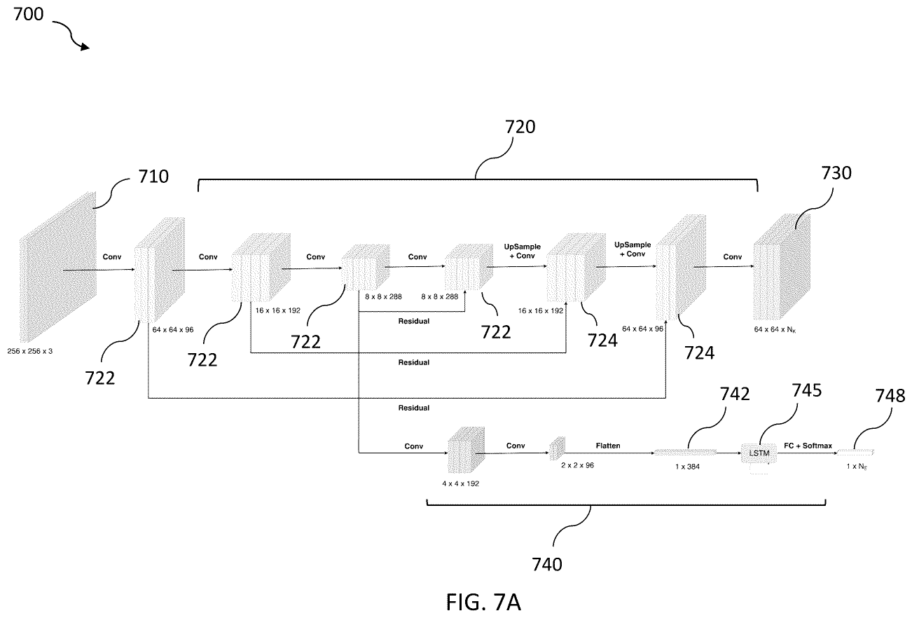

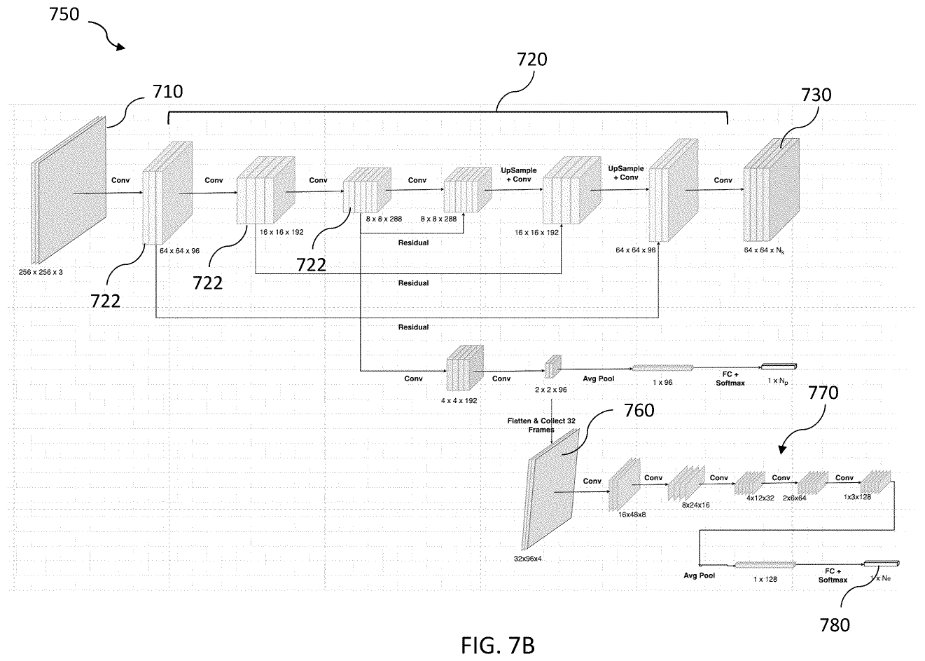

FIG. 7A depicts a framework 700 that utilizes keypoint detection techniques to classify an exercise in a sequence of images 710. The images 710, or feature map, are fed into a keypoint detector 720, where a series of downsampling (encoding) layers 722 and upsampling (decoding) layers 724 generate a predicted keypoint heatmap 730. The heatmap 730 is flattened via additional downsampling layers 740 into a context vector 742, which is fed into an LSTM (Long short-term memory) layer 745, which applies deep learning artificial recurrent neural network (RNN) modeling to the context vector 742. The LSTM layer 745, via the applied techniques, outputs an exercise classification 748 for the exercise depicted in the images 710.

FIG. 7B depicts a framework 750 that utilizes a series of convolution techniques to classify an exercise in a sequence of images 710. The framework 750 includes a 3D-CNN (three-dimensional convolution neural network) architecture or model that collects the feature maps across a fixed time window (16/32 frames) 760, collates them, and passes them through a series of convolution (Conv) layers 770 to obtain an exercise classification for the exercise depicted in the images 710.

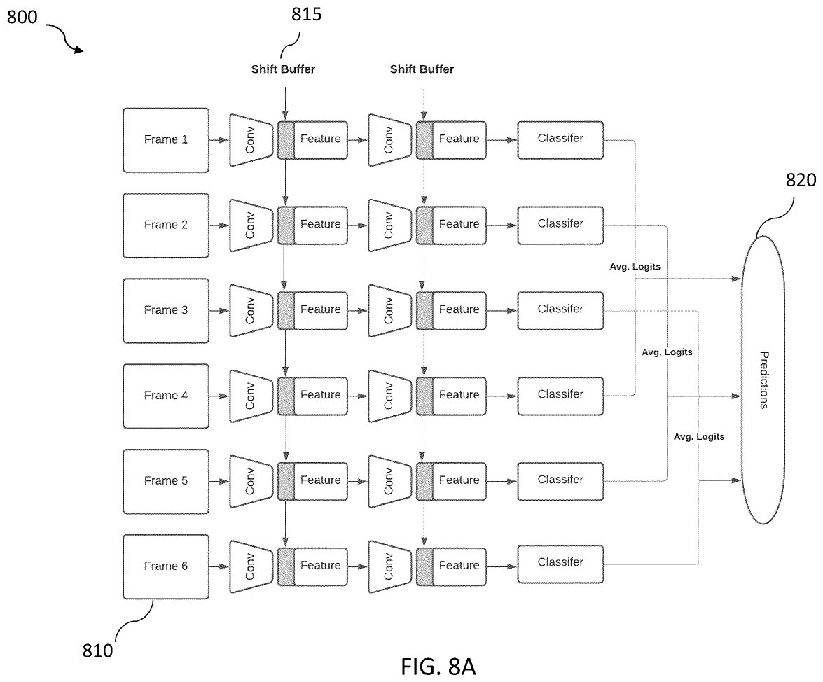

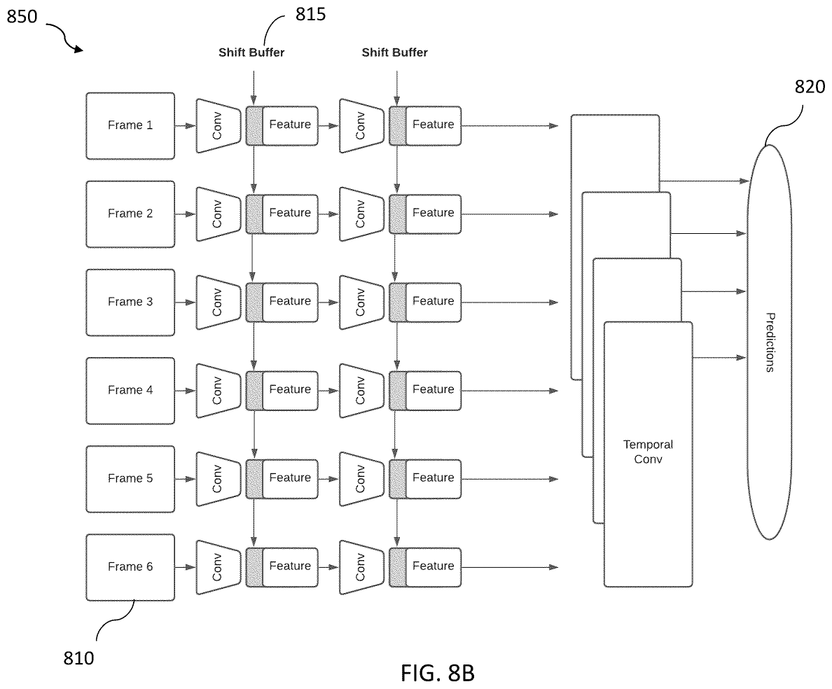

FIG. 8A depicts a framework 800 that utilizes a TSM (temporal shift module) architecture or model to perform edge exercise predictions to classify an exercise in a sequence of images 810. The framework 800 uses a MobileNetV2 backend that is pre-trained on generic action recognition datasets such as Kinetics, UCF, and so on. Once pre-trained, the backend can be tuned to predict and classify exercises 820 within the platform dataset of available or possible exercises.

The TSM is embedded within the MobileNetV2 backbone and includes shift buffers 815 that shift 1/8 of the feature maps +/−1 frame into the past and the future to exchange temporal information. The TSM is trained on clip lengths of 8 frames, representing a temporal window ranging from 1.6-4.8 seconds.

FIG. 8B depicts a framework 850 that includes a TSM combined with a 3DCNN head that utilizes the TSM shift buffer 815 described in FIG. 8A in combination with aspects of the 3DCNN framework 750 as described in FIG. 7B. This model utilizes a sequence of 16 frames to exchange temporal information and classify an exercise per frame without the complexity of a 3D convolution.

In some cases, the TSM predicts and/or classifies non-activities. For example, the framework 800 or framework 850 can include an additional classification head that outputs a prediction of “exercising” or “non exercising”, optionally using a multi-modal input conditioned on a current class context. For example, the current class context can be represented via a “content vector,” which predicts the probability an individual is exercising given current contextual cues from associated content (e.g., a class being presented to the user). The content vector is concatenated with the TSM feature map representing a sequence of frames and passed through a fully connected layer to predict an exercising/not exercising probability.

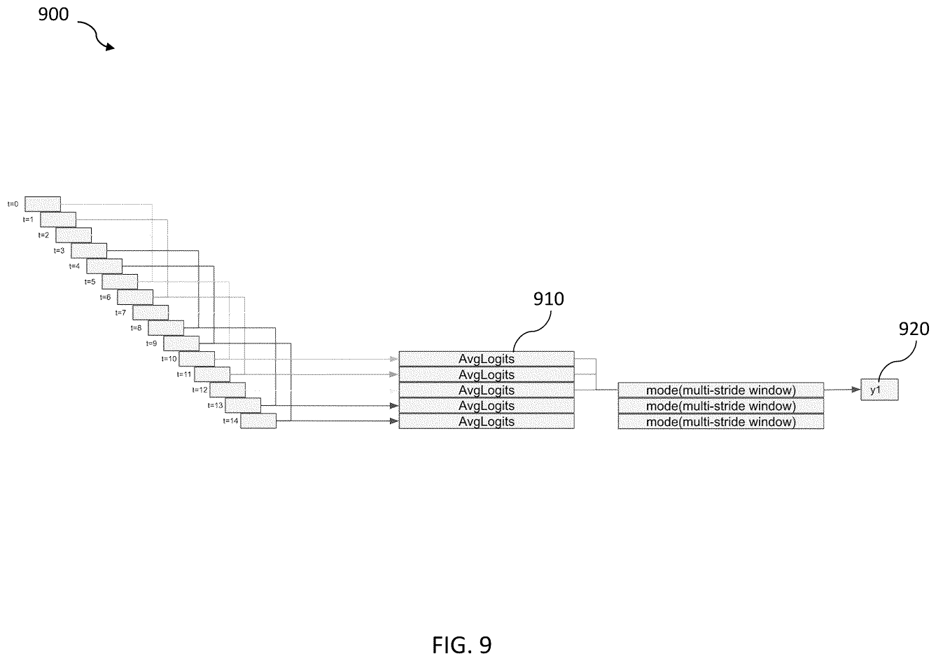

FIG. 9 depicts a striding logic framework 900, which, in association with the TSM framework 800, facilitates a robust real-time classification of exercises within a video stream. The logic framework 900 collects and averages classifier logits 910 over S frames (e.g., striding). The framework 900 classifies the mode of the argmax of the logits 910 to get a final exercise prediction or classification 920.

### Examples of Matching Based Methods

In some embodiments, the classification system 140, employs match recognition techniques to identify a pose that a person (e.g., the user 105) is performing within a set of images or video stream, such as the images 210. The action recognition techniques can be called “DeepMatch,” and utilize various metric learning techniques to classify poses depicted in images.

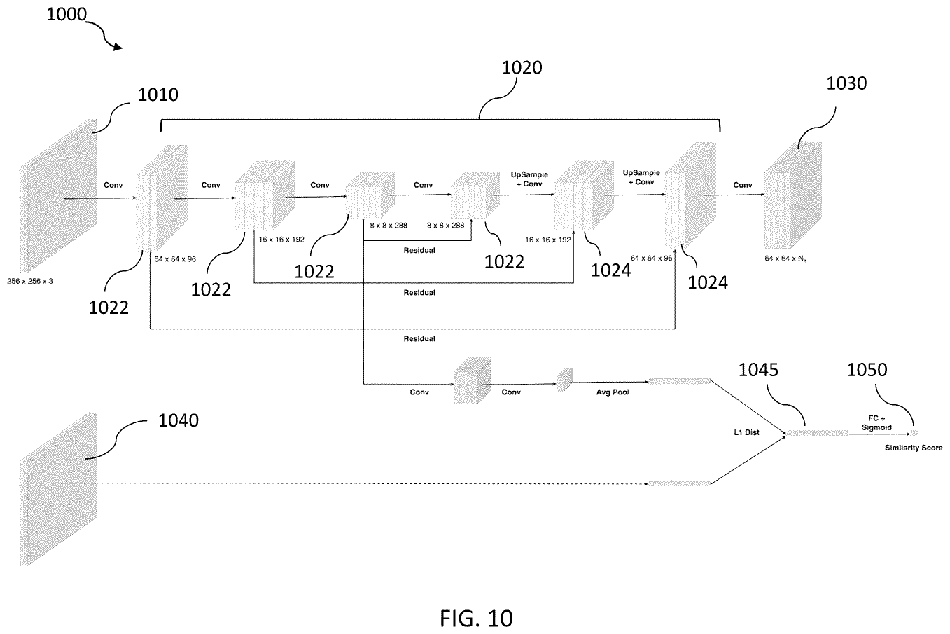

FIG. 10 depicts a match-based framework 1000 for classifying a pose or exercise of a user during an activity. The framework 1000 can include a Few-Shot Learning approach, where metric learning (e.g., a Siamese or Triplet Network learning) trains a network (e.g., a network that is optionally pre-trained for keypoint detection), to generate similar embeddings for images of people or users in similar poses.

The framework 1000 performs a person detector technique on an image 1010 to obtain the crop of a person, and then pass the crop to the network 1000. In some cases, the network is pre-trained on keypoint detection so that there is distilled knowledge about the human anatomy within the network 1000. Similar to the framework 700, the images 1010 (or cropped images) are fed into a keypoint detector 1020, where a series of downsampling layers 1022 and upsampling layers 1024 generate a predicted keypoint heatmap 1030.

The framework 1000 can utilize a manually curated group of poses for positive and negative samples. For example, the framework 1000 can utilize a hybrid approach that trains a classic Siamese network in an episodic manner (e.g., few-shot classification).

The framework 1000 includes a set of template embeddings 1040, which represent all possible poses of an exercise. Using a video stream or images 1000 of a person exercising, the framework generates an embedding, or the keypoint heatmap 1030, of the exercise in successive frames, and match 1045 the embedding 1030 to the template embeddings 1040 to determine a similarity score 1050 for the images 1000. For example, if the similarity score 1050 exceeds a match threshold score, the matched template pose is predicted to be the pose within the images 1010.

Thus, the framework 1000 can match captured images of users in poses, compare the images (or, crops of images) to a set of template images, and determine, identify, predict, or classify poses within the images based on the comparisons (e.g., identifying best or threshold matches images).

### Examples of Combined Classification and Matching Techniques

In some embodiments, the different techniques described herein are combined logically to improve or enhance the accuracy of the inferences output by the different frameworks. For example, a combination system that applies a technique that combines a classification framework (e.g., DeepMove) with a matching framework (e.g., DeepMatch) can provide a higher accuracy of outputs for the various systems (e.g., the follow along system 152 or the repetition counting system 158).

The combination technique (e.g., “ensemble”), combines the DeepMove and DeepMatch techniques to recognize the exercises or movements performed by a user. For example, when DeepMove predicts a certain exercise with a given threshold confidence, an associated system assumes the user is performing the exercise (e.g., following along). However, when DeepMove outputs a prediction below a threshold confidence level but does output an indication that the user is not performing an exercise (e.g., not following along) above the threshold confidence level, the associated system assumes the user is not performing the exercise.

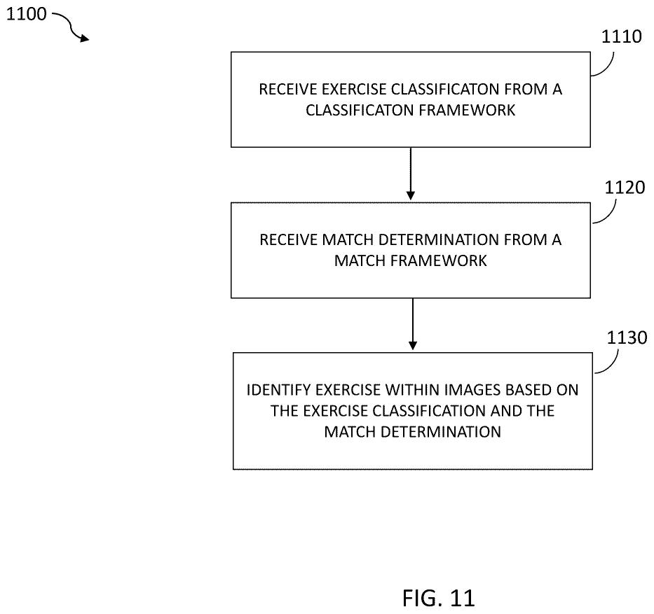

As described herein, the technology can incorporate information (e.g., predictions) from different frameworks when determining whether a user is performing an exercise, pose, movement, and so on. FIG. 11 is a flow diagram illustrating an example method 1100 for determining an exercise performed by a user. The method 1100 may be performed by the combination system and, accordingly, is described herein merely by way of reference thereto. It will be appreciated that the method 1100 may be performed on any suitable hardware or by the various systems described herein.

In operation 1110, the combination system, which can be part of a machine learning classification network, receives an exercise classification from a classification framework (e.g., DeepMove). The exercise classification can include a prediction that the user is performing a certain exercise with a given threshold confidence or accuracy.

In operation 1120, the combination system receives a match determination from a match framework (e.g., the match-based framework 1000, such as DeepMatch). The match determination can include an indication of a matched exercise (e.g., based on a comparison of embeddings) and a confidence or probability for the matched exercise.

In operation 1130, the combination system identifies an exercise within images based on the exercise classification and the match determination. For example, the system can utilize the exercise classification prediction and the match determination, along with the confidence levels for the outputs, to identify or determine the exercise or movement performed by the user.

### Examples of Verifying Exercises for Follow Along Systems

As described herein, the follow along system 152 can utilize the classification information (e.g., pose or exercise classification) to determine whether the user 105 is “following along” or otherwise performing an activity being presented to the user 105 (e.g., via the user interface 125). For example, the follow along system 152 can include various modules, algorithms, or processes that filter predictions (e.g., noisy predictions) output from the classification system 140 and/or verify poses, exercises, and/or sequences of poses/exercises.

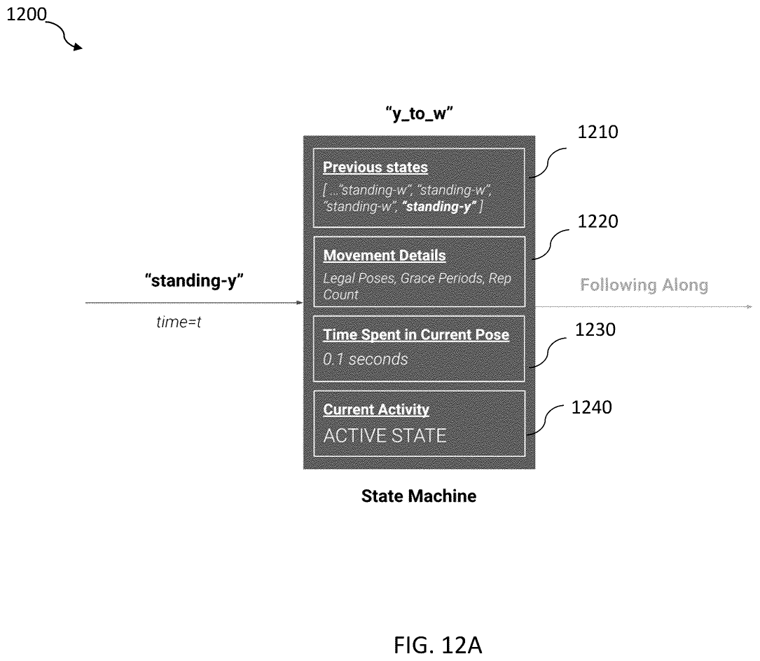

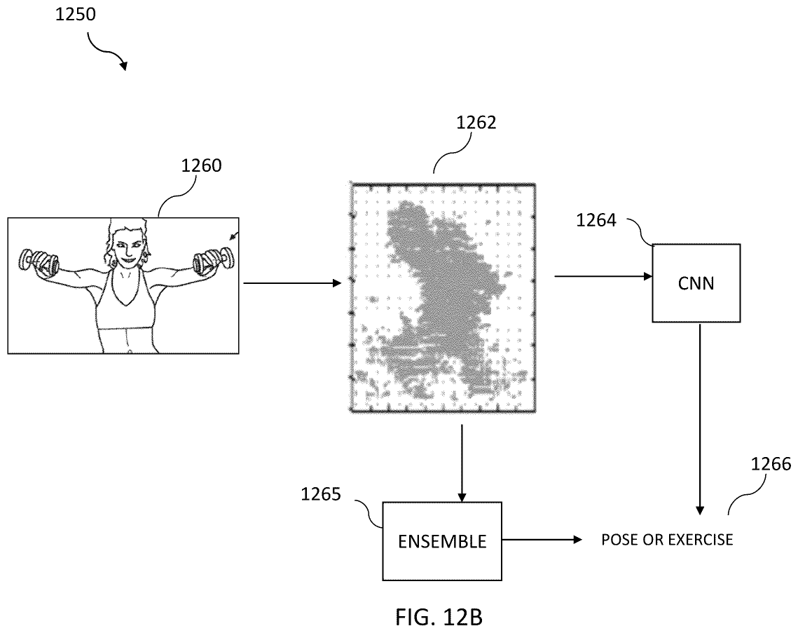

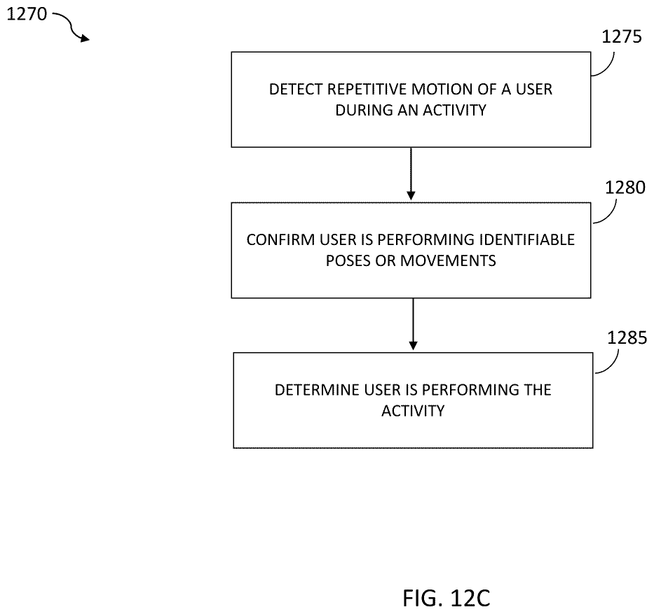

In some embodiments, the follow along system 152 includes a state machine or other logical component to identify and/or verify a status associated with a user when performing an activity (e.g., a status that the user 105 is performing a presented activity). FIG. 12A is a diagram illustrating a pose state machine 1200. The pose state machine 1200 provides or includes logic that receives a sequence of poses output by the classification system 140 (e.g., via a DeepPose classifier and/or DeepMatch classifier) and determines or generates a status for the user (e.g., the user is “following along”).

For example, the follow along system 152 can verify that a user is moving through a list of legal or predicted poses: Standing->Squatting->Standing for Squats, during a presented class.

The state machine 1200, in some cases, functions as a tracking system. The state machine can track information related to “previous states” 1210, such as observed poses or time, information identifying a time spent in a current pose 1230, and movement details 1220 for a pose or movement being completed. The movement details 1220, which are compared to the previous state information 1210 and the current pose time information 1230, can include: (1) poses that should be seen while completing each movement exercise (“Legal Poses”), (2) an amount of time allowed to be spent in each pose (“Grace Periods” or “Timeouts”), and/or (3) rep counts.

The state machine 1200, based on the comparison, determines the state of the system as “Active” or “Not Active,” which informs a status for the user of following along or not following along. In some cases, such as when exercises have variations (e.g., a bicep curl has variations of seated, standing, kneeling, and so on), the state machine 1200 considers any variation as a legal or verified pose.

In some cases, such as when the system 152, based on the state machine 1200 and the combination technique described herein, verifies the user is currently in a not active state (e.g., engaged in a non-activity or otherwise not performing an exercise activity), such as sitting, walking, drinking water, and so on), the system 152 determines that the user is not following along.

In some embodiments, the follow along system 152 includes an optical flow technique to verify the exercise activity performed by a user. FIG. 12B is a diagram illustrating a verification system using an optical flow technique 1250. Optical flow is a technique that produces a vector field that gives the magnitude and direction of motion inside a sequence of images.

Thus, for an image pair 1260, the system 152 can apply the optical flow technique and produce a vector field 1262. The vector field 1262 can be used as a feature set and sent to a neural network (e.g., the convolution neural network 1264) and/or the combination technique 1265 (e.g., “ensemble,” described with respect to FIG. 11), which use the vector field to determine a pose or exercise 1266 within the image pair, to identify or verify the user is performing a certain motion, such as a repetitive motion.

For example, the optical flow technique can act as a verification system, either in conjunction with a classification or matching framework (e.g., DeepMove plus DeepMatch) or alone. Thus, if the optical flow technique 1250 detects repetitive motion and, the classifier, such as DeepMatch, detects legal poses or movements, the follow along system 152, despite a less than confident exercise verification, can credit the user with a status of following along to an activity. In some cases, the follow along system 152 can determine that technique 1250 has detected repetitive motion (e.g., during a dance class activity), and credit the user, without any classification of the movements.

FIG. 12C is a flow diagram illustrating an example method 1270 for determining an exercise performed by a user. The method 1270 may be performed by the follow along system 152 and, accordingly, is described herein merely by way of reference thereto. It will be appreciated that the method 1270 may be performed on any suitable hardware or by the various systems described herein.

In operation 1210, the system 152 detects a repetitive motion of a user during an activity. For example, the system 152 can employ the optical flow technique 1250 to detect or determine the user is repeating a similar motion (e.g., a sequence of the same movements).

In operation 1220, the system 152 confirms the user is performing identifiable poses or movements during the repetitive motion. For example, the system 152 can utilize the state machine 1200 to confirm that the user is performing identifiable or legal poses or movements (e.g., poses or movements known to the system 152).

In operation 1230, the system 152 determines the user is performing the activity, and thus, following along to a class or experience. For example, the system 152 can credit the user with performing the activity based on the combination of determining the repetitive motion and identifying the poses or movements as known poses or movements.

In some embodiments, the optical flow technique produces a vector field describing the magnitude and direction of motion in a sequence of images. Utilized along with the pose or exercise classifiers (e.g., utilized with Ensemble), the optical flow technique can verify that a user is actually moving, avoiding false positive inferences of performed movements or inferences.

The optical flow technique determines a user is moving as follows. Identifying the detected body key points as the initial points, the technique uses sliding windows to track min/max X & Y coordinates of each of the initial points and determines whether each point moves when (X_max−X_min) and/or (Y_max−Y_min) is above a threshold. The technique then determines motion happens when the number of the moving points is above a threshold number of moving points. The threshold number/values can be set with a variety of different factors, including the use of experimentation and/or hyperparameter tuning.

As a first example, for exercises that require being still and holding a pose (e.g., a plank): when the optical flow technique detects no movement above a certain threshold the combination technique also detects or infers the exercise, the system predicts the user is performing the exercise.

As another example, for exercises that require motion, when the optical flow technique detects motion above a certain threshold in the X and/or Y axes and the combination technique also detects that exercise, the system predicts the user is performing the exercise.

In addition to the optical flow technique, the system 152 can employ autocorrelation when detecting repetitive motion and verifying performance of an activity. The system 152 can utilize autocorrelation techniques and peak finding techniques on embeddings generated by the DeepMatch/DeepPose frameworks described herein to detect repetitive motion, and verify a user is following along.

In some embodiments, the following along system 152 utilizes test sets that balance different conditions associated with workout environments, user characteristics, and so on. For example, the system 152, before being utilizes to perform exercise recognition and confirmation is tested against a dataset of videos that cover various environmental conditions (e.g., lighting conditions, number of background people, etc.) and people with different attributes (e.g., body type, skin tone, clothing, spatial orientation, and so on). Such testing is above certain thresholds, including a minimum of 15 videos per exercise, with certain coverage of each attribute or characteristic or variable (e.g., at least four videos for each of fitzpatrick skin tones [1-2, 3-4, 5-6] and at least three videos for each body type [underweight, average, overweight] and at least two videos for each orientation [0, 45, 90 degrees]).

Given a limited number of videos (or other visual datasets), the testing system can utilize a smaller number of videos or data and optimize the testing with fewer videos. For example, the system can employ a solution that tracks the 0-1 Knapsack problem, when the videos are the items, the capacity is N (e.g., set to 15 or other amounts), and a value of similarity of the knapsack's attribute distribution to the desired distribution is the value to be maximized. Thus, the system 152 can train or otherwise be enhanced based on a smaller data set (e.g., fewer videos) while being optimized for different exercise conditions or differences between activity performances, among other benefits.

In some embodiments, the computer vision frameworks and models described herein can be trained using video clips of performed exercise movements (e.g., a data collection pipeline) that is supplemented by 3D modeling software that creates animated graphics of characters performing the same or similar movements (e.g., a data generation pipeline). By generating the data (e.g., 3D characters performing movements), the system can scale or generate any number of training datasets, among other benefits.

Generating the pipeline (e.g., synthetic data or video clips of CGI 3D characters completing exercises) includes collecting exercise animation data. The data can be collected via motion capture technology, which matches the joints of a source actor completing the movement to the joints of a virtual skeleton. The virtual skeleton is then transferred to any number of 3D characters to provide representations of different “people” with varying attributes completing the same exercise.

The system can then place the 3D characters into full 3D environments using 3D graphics software, where environmental attributes are tunable. These attributes include camera height, lighting levels, distance of character to camera, and/or rotational orientation of the character relative to the camera. The system exports rendered animation clips via the pipeline, which are used as synthetic training data for computer vision applications.

### Examples of Performing User Focus Functions

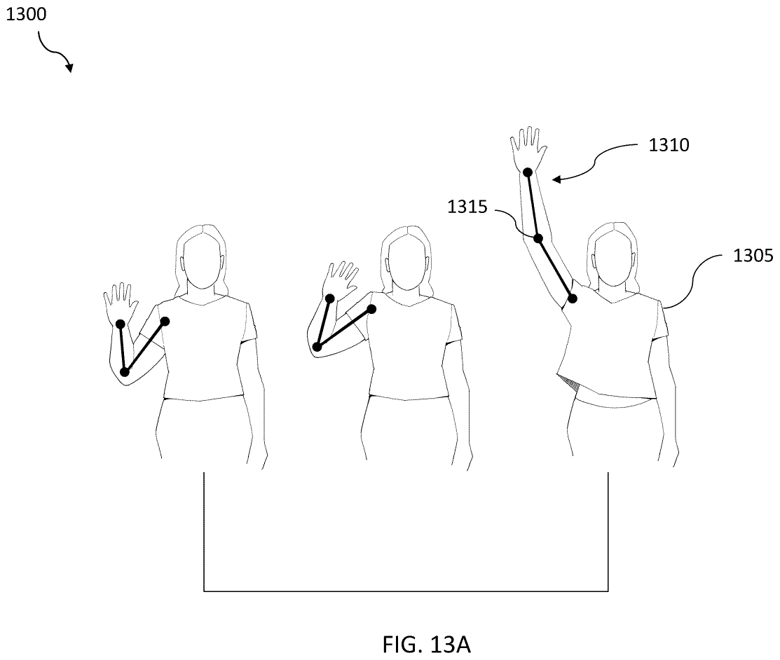

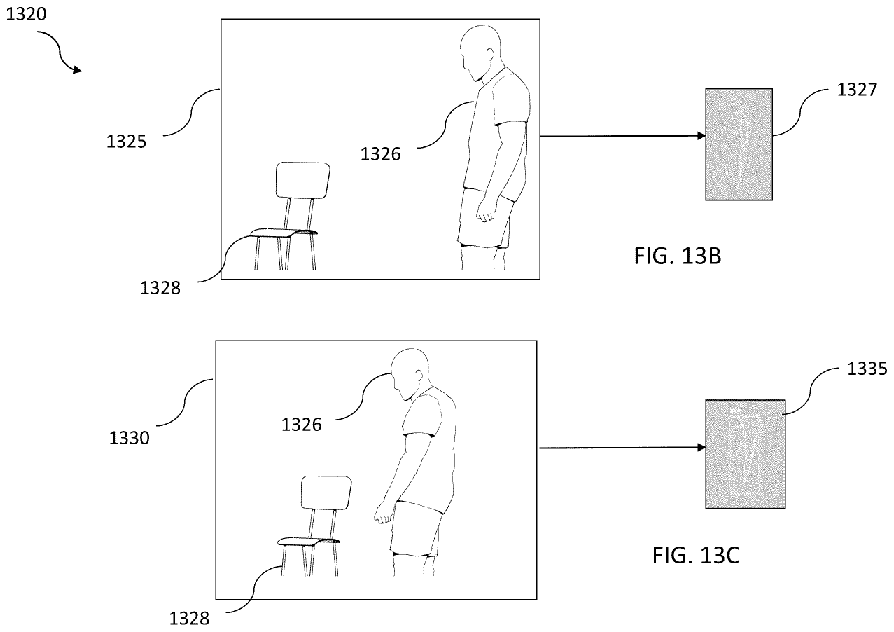

As described herein, a lock on system 154 can utilize the classification information to determine which user, in a group of users, to follow or track during an activity. The lock on system 154 can identify certain gestures performed by the user and classified by the classification system 140 when determining or selecting the user to track or monitor during the activity. FIG. 13A is a diagram illustrating a lock-on technique 1300 for identifying a user to monitor during an activity.

The lock on system 154 is a mechanism that enables users to perform a hand gesture or other movement to signal to the system 154 which user should the system 154 track and focus on, in the event there are multiple people working out together.

The system 154 receives key points from a keypoint detector (e.g., keypoint detector 720 or 1020) and checks against predefined rules and/or uses an ML classifier (as described herein) to recognize the gesture (e.g., as a pose). The system 154 can include a tracking algorithm that associates unique IDs to each person in the frame of images.

The system 154 can select the ID of the person who has gestured as a “target user” and propagates/sends the selected ID to the repetition counting system 158 and/or the follow along system 152 for repetition counting or follow along tracking. In some cases, the system 154 can include template matching, where users provide information identifying a pose or gesture to be employed when signaling to the system 154 the user to be monitored during the activity.

For example, the system 154 can identify user 1305 when the user 1305 performs a certain pose/gesture, such as a pose or gesture of a “right-hand raise” 1310. The system 154, using the various techniques described herein, can identify the pose/gesture within the image based on the key points 1315 being in a certain configuration or pattern (and thus satisfying one or more rules), and select the user as a user to lock onto (or monitor or track) during an exercise activity.

Of course, other poses/gestures (heads nods, leg movements, jumps, and so on, including poses/gestures capable of being performed by all users) can be utilized when the lock on system 154 selects a person or ID within an image to follow along or otherwise track for exercise verification or other applications.

Further, as described herein, a smart framing system 156 tracks the movement of the user 105 and maintains the user in a certain frame over time (e.g., with respect to other objects in the frame) by utilizing classification information when tracking and/or framing the user. FIGS. 13B-13C are diagrams 1320 illustrating the smart framing of a user during an activity.

FIG. 13B depicts the tracking of a person 1326, paused at a first movement state 1325, with respect to an object 1328 (or other objects) within the frame. The smart framing system 156 utilizes a PID (proportional-integral-derivative) controller to create an “AI Cameraman” where the system 156 follows the person, in a wide-angle camera setting, within the frame.

The system 156 receives information from a person detector (such as bounding box information), outputting a tracking image 1327 of the person in the first movement state 1325. For example, the system 156 receives a person location as an input signal, outputs information that is proportional to the difference between a current AI Cameraman or smart frame location and the input person location. For example, the system 156, as depicted in FIG. 13C, outputs a tracking image 1335 that is based on an updated movement state 1330 of the person 1326 (e.g., with respect to the object 1328).

As described herein, the exercise platform can employ a classification system 140 that utilizes various classification techniques to identify and/or classify poses or exercises being performed by users. Various applications or systems, as described herein, can utilize the classification information to verify a user is exercising (e.g., is following along), and/or track or focus on specific users, among other implementations.

### Examples of Repetition Counting for an Exercise Activity

As described herein, the various computer vision techniques can inform repetition counting systems, or rep counting systems, which can track, monitor, count, or determine a number of repetitions of movements performed by a user during an exercise activity or other activity. For example, the repetition counting system 158 (e.g., “rep counting system”) can utilize the classification or matching techniques described herein to determine a number of repetitions of a given movement or exercise are performed by the user 105, such as during certain types of interval- or repetition-based segments (e.g., EMOM or AMRAP segments).

As described herein, the repetition counting system 158 may determine a user performing a workout has completed the workout and/or a stage or segment of the workout. The repetition counting system 158 may perform repetition or rep counting, as described herein, to determine the user has achieved a target number of repetitions within a workout segment (e.g., a minute long segment or round) and perform an action in response to the determination.

For example, the system 158 may determine that the user has achieved the goal or target for the segment (e.g., a certain number of repetitions of one or multiple movements), and provide the user with credit (e.g., credit within the user's workout summary and/or body activity database with an achieved number of repetitions or rounds). As another example, the system 158 may determine the user has completed a certain number of repetitions and move the user to a next segment (e.g., presenting the next segment to the user via a streaming workout activity).

Thus, while the user is performing a repetition-based workout or segment (e.g., the EMOM, or “every minute on the minute” segment and/or the AMRAP, or “as many rounds as possible” segment), the system 158 can track/count the repetitions performed by the user during those segments (or rounds) and perform actions accordingly.

### Examples of Repetition Counting Architectures

In some embodiments, the system 158 can utilize the exercise detection modules (e.g., DeepMove and DeepMatch) to count the number of exercise repetitions a user is performing in real time. For example, the system 158 can utilize “inflection points,” which are demarcated as the high and low points of a repetitive motion. The system 158 can track the high and low points as the user performs an exercise to identify how many cycles of a high/low repetition a person has performed.

The system 158 identifies the high and low points via an additional model head (e.g., a single fully connected neural network layer) that sits on top of the DeepMove framework. In some cases, the framework includes an exercise specific model head for each exercise, since high and low points can be unique for each exercise. Further, the system 158 can train the exercise heads together (e.g., along with follow along). Thus, the model can perform multiple tasks-follow along, rep counting, and/or form correction, simultaneously and in parallel to one another.

Once the model has predicted high/low points, the system 158 tracks the transitions across time in a simple state machine that increments a counter every time an individual hits a target inflection point, where the target is a threshold on the model prediction. The target can be either high or low, depending on the exercise. To increment a rep counter, the system also determines the user is following along, as described herein. Further, as the repetition count changes over time, the system 158 can derive or determine rep cadence that identifies a cadence of the user performing exercise repetitions.

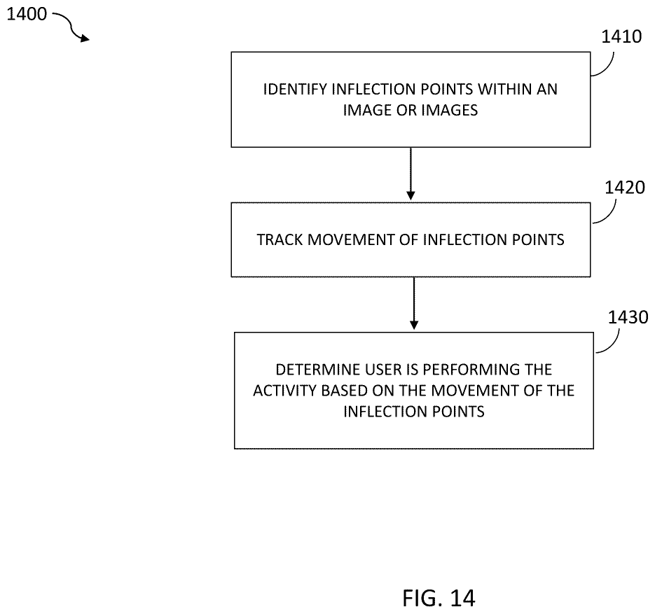

FIG. 14 is a flow diagram illustrating an example method 1400 for counting repetitions of an exercise performed by a user. The method 1400 may be performed by the rep counting system 158 and, accordingly, is described herein merely by way of reference thereto. It will be appreciated that the method 1400 may be performed on any suitable hardware or by the various systems described herein.

In operation 1410, the system 158 identifies one or more inflection points within an image or images of a user performing an exercise activity. For example, the system can identify high and low points of a repetitive motion performed by the user within the images (e.g., a hard or shoulder).

In operation 1420, the system 158 tracks the movement of the inflection points. For example, the system 158 can identify how many cycles of a high/low repetition a person has performed, such as a cycle from a low point, to a high point, and back to the low point (or a related low point).

In operation 1430, the system 158 determines a user is performing the activity based on the movement of the inflection points. For example, the system 158, once the model has predicted high/low points for the exercise, tracks the transitions across time in a simple state machine that increments a counter every time an individual hits a target inflection point or completes a movement cycle, where the target is a threshold of the predictive model.

Thus, using RGB or other 2D sensors (e.g., images captured by RGB sensors), the system 158 can perform repetition counting for a user, such as when the user 105 is performing various exercises during a live or archived exercise class.

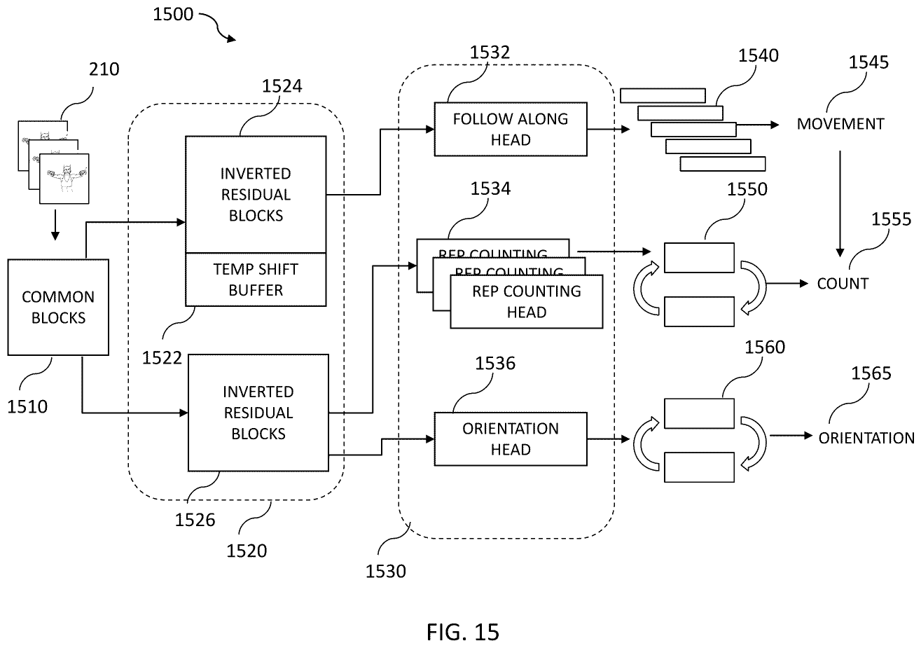

FIG. 15 is a diagram illustrating a multi-task model architecture 1500 that performs multiple exercise tasks. As described herein, the DeepMove framework can provide a temporal model for multiple exercise tasks, such as when utilizing the temporal shift module (see FIG. 8A). The architecture includes an inference pipeline that is “uni” directional (e.g., there is temporal information from the past) and uses a multi-strided window to incorporate temporal information spanning multiple time windows (e.g., frame×frame prediction depicted in FIGS. 8A-8B).

Thus, the DeepMove model architecture can be modified to support a multi-task configuration that performs temporal and/or spatial reasoning tasks. The temporal task of “Follow Along” is separated into a separate “branch” with its own Follow Along predictor head. A separate “branch” for spatial tasks has been added to support additional features, such as repetition counting, orientation detection, form correction, and so on. The two branches share a common base, which is configurable to share more/less of the model weights, depending on the desired model size. In some cases, the model is trained with “Follow Along” (as described herein) as a first task to create a coarse or base model suitable for fitness applications and fine-tuned for the spatial task specific requirements of rep counting and orientation prediction, as described herein.

The model architecture 1500, therefore, can receive a set of images 210, such as a video stream of a user performing an exercise activity, via a common blocks module 1510 (e.g., part of the MobileNetV2 described herein). The common blocks module 1510 may include a series of convolution layers (or other operations) that produce a common set of features for input into subsequent modules or layers. An extended MobileNetV2 backbone 1520 receives the common set of features via different task performance branches. For example, the temporal branch can receive the common blocks via a temporal shift buffer 1522 and generate inverted residual blocks 1524. The extended backbone 1520 can also receive the common blocks and generate inverted residual blocks 1526 within or as part of the spatial path.

Task performance branches 1530, such as various predictor heads, receive the residual blocks from the backbone 1520. For example, a follow along head 1532 that is part of the temporal path (e.g., a spatio-temporal path), as described herein, receives the output of the residual blocks and generates logits 1540, which represent whether a user is performing a specific or intended movement 1545 (e.g., a bicep curl).

The spatial path includes additional predictor heads, such as one or more rep counting heads 1534 (e.g., a head for each movement to be counted) and an orientation head 1536. The rep counting heads 1534 determine a prediction (e.g., identifying whether the user moved “high” versus “low”) 1550, and determines (e.g., computes) a “rep count” 1555 when the user has performed the movement (e.g., a bicep curl head of the predictor heads 1534 will determine a count 1555 every time a user performs a bicep curl). The orientation head 1536 determines a prediction 1560 that a user has a correct orientation 1565 to a camera capturing the images 210. Further details regarding the functionality of the model architecture 1500 and the predictor heads 1532, 1534, 1536 are described herein.

In some embodiments, the repetition counting system 158 can include an inflection detection module (e.g., an inflection detector) that utilizes the spatial path predictor heads (e.g., the rep counting heads 1534) to perform repetition counting for each exercise or movement. For example, the rep counting heads 1534 can have a unique predictor head for each movement, where the predictor head predicts or determines an output prediction of “target” (e.g., likely performed the expected movement) or “other” (e.g., likely did not perform the expected movement).

Using the output from the predictor heads, the inflection detection module can generate or produce a softmax probability that identifies where a user is (e.g., how many repetitions) within a current exercise or repetition cycle. A state machine (e.g., similar to the state machine 1200) can receive the softmax probability, and if the probability passes an optimized confidence threshold for a specific number of frames of the set of images 210, the state machine changes its state.

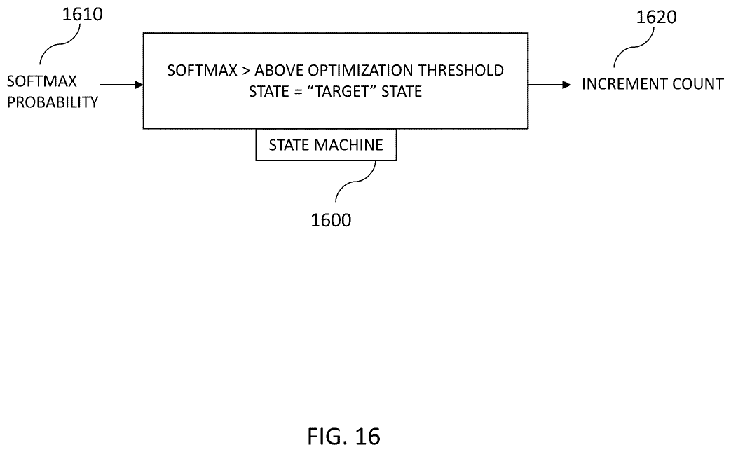

FIG. 16 is a block diagram illustrating a state machine 1600 for repetition counting. The state machine 1600 receives a softmax probability 1610 and changes to a “target” state, causing an output 1620 to increment a repetition counter for the user during the exercise. Thus, the system 158, via the inflection detection module and its state machine 1600, can count repetitions based on the exercises being performed, and not based on timing or periodicity between movements, among other benefits.

Like rep counting, the repetition counting system 158, in some embodiments, can include an orientation detection module (e.g., an orientation detector) that utilizes the spatial path predictor heads (e.g., the orientation head 1536) to determine a user's orientation with respect to a camera capturing the video stream. For example, the orientation head 1536 predicts or determines an output prediction of 0 degrees (e.g., correct orientation) or 90 degrees (e.g., incorrect orientation) with respect to the camera.

Using the output from the predictor heads, the orientation detection module can generate or produce a softmax probability that identifies whether the user's orientation is correct or incorrect (e.g., so the system can receive images in a correct orientation to perform rep counting). A state machine (e.g., similar to the state machine 1200 or the state machine 1600) can receive the softmax probability, and if the probability passes an optimized confidence threshold for a specific number of frames of the set of images 210, the state machine changes its state.

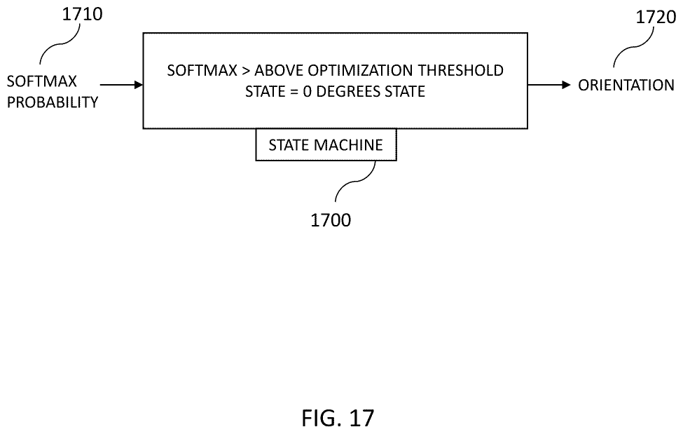

FIG. 17 is a block diagram illustrating a state machine 1700 for determining orientation. The state machine 1700 receives a softmax probability 1710 and changes to an orientation state (e.g., 0 degrees state) causing an output 1720 that indicates the orientation. In some cases, the system 158 may determine the orientation for each movement, for some movements, or for all movements of a class or activity.

The system 158 (or another system described herein), can receive the orientation output 1720 and present an indication to the user to adjust their orientation. For example, when the user is watching a streamed exercise class or otherwise performing exercises in front of a user interface, the system 158 can display a nudge or instruction to modify or change how the user is oriented with respect to the camera (e.g., a displayed phrase, such as “turn your mat 90 degrees,” an example graphic, and so on). The system 158 may also present the indication via audio cues or other visual elements or graphics.

In some embodiments, the repetition counting system 158 may utilize frequency domain analysis method estimation techniques, in addition to or in place of the time domain techniques (e.g., rep counting based on a target state) described herein. The system 158 may perform repetition counting by estimating the cycle length of a “target” to a “target” that is embedded in a measured target confidence signal and use the determined/estimated cycle length from “target” to “target” to count or track repetitions.

In some cases, the system 158 can employ subspace-based super resolution frequency (spectrum) estimation methods, such as signal-based methods (e.g., MUSIC, or multiple signal classification), and/or noise-based methods (e.g., ESPRIT, or estimation of signal parameters by rotational invariance techniques). FFT, or Fast Fourier Transformation, is a method for estimating the frequency of signals, where, in some cases, a frequency resolution of FFT is dependent upon the size of the temporal window. The greater the length of the time window, the higher the frequency resolution. Both MUSIC and ESPRIT operate by separating the noisy signal into signal subspace and noise subspace (where in some cases ESPRIT can be more computationally efficient).

As an example, ESPRIT estimates a signal subspace S from an estimate of a signal covariance matrix R. The steps performed on the eigen vectors forming the signal subspace S can include: (1) split the matrix S into two staggered matrices S1 and S2 of size (M−1)× p each, where M is the model order and p is the number of sinusoids (S1 is matrix S without the last row and S2 is the matrix S without the first row), (2) divide the second matrix S2 by S1 using the Least Squares (LS) approach to obtain matrix P. The angles of eigenvalues of P provide an estimate of the signal frequency.

Frequency based methods perform the analysis on a segment of signals. Thus, the system 158 can apply ESPRIT on a short time windowed target confidence signal and performs ESPRIT in an overlapped manner on the time window to achieve real-time rep counts. In some cases, the frequency of each overlapped time window is the average frequency of contributors to the window.

For some implementations, the system 158 may utilize an approach that determines, in real-time, a period in which an action is repeated within a set of frames, such as a video stream of images (e.g., the set of images 210). For example, a framework such as RepNet, that functions as a video repetition counter, can be adapted to receive overlapping batches of frames and perform repetition counting in real-time or near real-time.

A video repetition counter may use a feature encoder to extract image features and a transfer to predict periodicity between the frames. The counter then aggregates per frame periodicities (e.g., predicted by the transformer) to determine a total repetition count for the video across a clip or set of frames.

To perform the repetition counting in real-time, the system 158 can utilize a feature encoder to generate embeddings (using the frameworks described herein) and input batches of frames into the prediction models. In some cases, a stride selection algorithm can be used to determine the best stride at runtime.

As described herein, the repetition counting system 158, may employ a combination of techniques when counting repetitions of a movement or movements when a user is performing an exercise activity. For example, the system 158 can perform a combination, via ensemble logic (see also FIG. 12B), of the model depicted in FIG. 15 and the ESPRIT technique.

Once follow along (FA) is activated (e.g., based on follow along gating), such as when a user begins a class, segment, or movement, the system 158 employs a TSM-based approach to predict movement occurrences, because there is little or no delay (e.g., due to frame buffering of the set of images 210).

After an initial buffering time, the system 158 employs ESPRIT (or MUSIC) to predict movement occurrences and syncs the two approaches after a certain number of frames (e.g., every 5 frames). During the syncing, the system compares the repetition counts determined by both approaches and utilizes the TSM determined count when there are no differences (or a low difference of 1 repetition). However, the system 158 shifts to employ ESPRIT rep counting when the differences are greater than one repetition, until the next sync between approaches.

In some cases, when follow along deactivates for a prolonged period (e.g., 2.5 seconds), the system 158 resets the ESPRIT algorithm, and frames are buffered upon FA reactivation. The system 158 employs the TSM approach for rep counting until ESPRIT can be utilized.

Further, in some cases, the techniques can combine multiple inputs from various signals (e.g., ESPRIT, TSM, Keypoints, and/or Optical Flow) either using a rule-based system, or a trainable ML system using either XGBoost or a Neural Net algorithm, called heterogeneous ensemble learners.

Thus, the repetition counting system 158 can utilize one or more approaches described herein when performing rep counting or tracking of movements performed by a user during a workout or exercise activity.

### Examples of Repetition Counting Using Keypoint Detection

In some embodiments, the system 158 may utilize keypoint detection techniques, as described herein, to assist in repetition counting, exercise tracking and recognition, and other actions.

For example, the system 158 may generate signals from body keypoints (see FIG. 13A), such as:

The angle between or formed by joints (e.g., an angle of an elbow joint during a bicep curl) during a movement or exercise;

The alignment between 3 key points (e.g., the alignment of a shoulder, elbow and wrist during a lateral raise);

Representative X and Y coordinates of keypoints (e.g., a hip y coordinate during squats); and/or

The distance between keypoints (e.g., a shoulder to wrist distance during a bicep curl) during a movement.

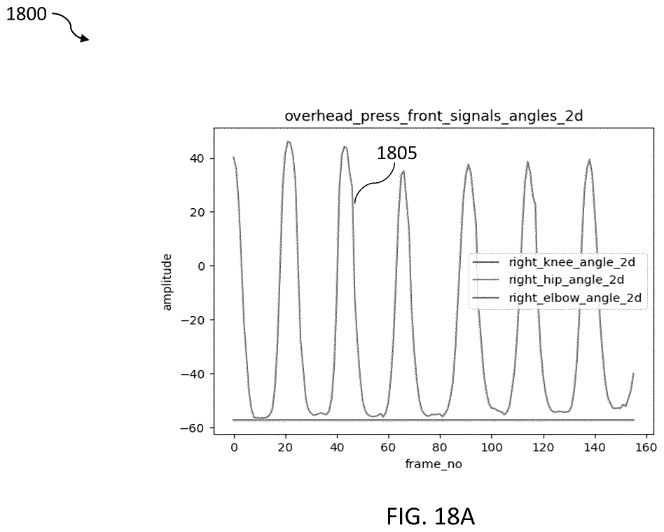

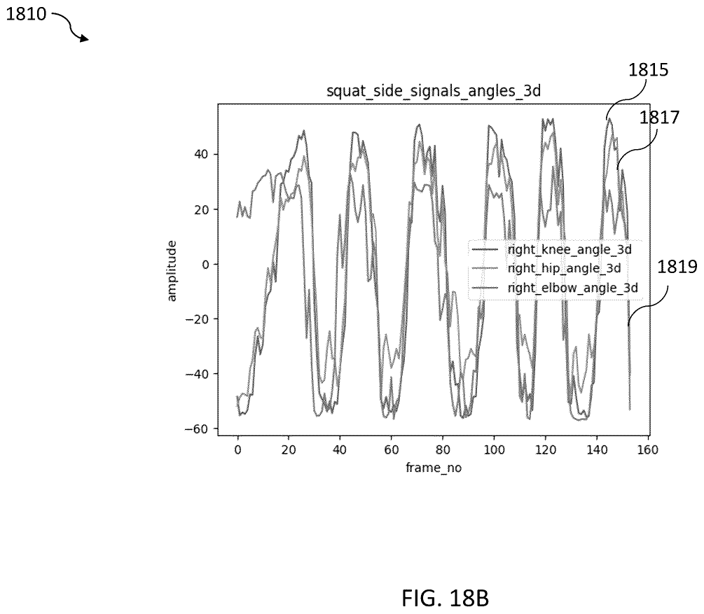

FIGS. 18A-18B depict signals generated by keypoint detection, such as by two-dimensional or three-dimensional keypoint detection. As a first example, FIG. 18A is a graph 1800 that depicts a changing “right knee angle” as a signal 1805 in 2D over a series of frames captured by a user performing an overhead press movement.

Next, FIG. 18B is a graph 1810 that depicts a changing “right knee angle” as a signal 1815 in 3D, a changing “right hip angle” as a signal 1817 in 3D, and a “right elbow angle” as a signal 1819 in 3D, over a series of frames captured by a user performing a squat movement.

For example, given a cyclic signal, the system 158 can implement several methods to compute the peaks and valleys, and perform peak detection. Using peaks and valleys from multiple signals, the system 158 may employ a voting mechanism to find agreement across signals. The system 158 determines a peak at every point of inflection or change in direction. Given that signals may be noisy, the system 158 may smooth the prediction of change.

The system 158, in some cases, can employ a multi-dimensional neural network that is trainable by any input signal that encodes movement (e.g., optical flow, Inertial Motion Units (IMUs) with gyroscope and accelerometer data, 2D or 3D human body keypoints, and so on). Given an input of one or several of the signals, the neural network performs multi-task prediction for exercise recognition and repetition detection or counting. To learn the temporal relationship between signals that predict the occurrence of a repetition, the deep neural network learns to count a full cycle (0 to 100%), otherwise memorization of the peak or inflection pose may occur.

Thus, the system 158 can provide benefits, such as a deep neural network training, including training for exercise recognition. The system 158, via the training, can distinguish between exercises as well as times when a user is “not exercising,” can perform repetition detection, and can do so in a computationally lightweight manner, among other benefits.

### Examples of Repetition Counting Using Optical Flow

As described herein, the system 158 may employ optical flow techniques when performing repetition counting or tracking. Optical flow can include the motion of objects between consecutive frames of sequence, caused by the relative movement between the object and a camera.

In some cases, sparse optical flow provides flow vectors of some “interesting features” (e.g., few pixels depicting the edges or corners of an object) within a frame, whereas dense optical flow gives the flow vectors of the entire frame (e.g., all pixels)—up to one flow vector per pixel. Often, dense optical flow has higher accuracy/resolution at the cost of being slow/computationally expensive.

The system 158, in some embodiments, can utilize sparse optical flow for repetition counting as follows. First, the system 158 may determine features to track from a first frame, by using pose or body keypoints; dividing a body in a bounding box into bins and a take center of the bins, use a “good features to track” function from OpenCV; and so on.

Next, the system 158 maps each feature to a separate track. Then, the system 158 may track and update points in subsequent frames for each tracker (e.g., using a Lucas-Kanade Sparse Optical Flow algorithm).

Since a movement is known, an axis of oscillation is known and thus keypoints that produce the maximum motion are known. For example, for a squat, the Y component has the maximum motion, and keypoints such as the shoulder, hip, and knees will have a maximum deviation. The system 158 may maximize such knowledge by computing projection across the axis of oscillation.

In some cases, based on the camera's orientation with respect to a ground plane, the motion of a person is either horizontal or vertical in the image plane. For example, the motion produces a waveform. Using real-time peak detection techniques, the system 158 can measure inflection point. In some cases, false peaks can be eliminated using various techniques, such as real-time detection of neural oscillation bursts.

The system 158, in some embodiments, can utilize dense optical flow for repetition counting as follows. First, the system 158 determines dense (e.g., at every pixel) optical flow velocity components u and v for each frame, determining the vector magnitude and angle at each pixel.

The system 158 employs an accumulator image that keeps track of the repetitions (where this count increments twice for each rep). The accumulator image is reset to zero at the start of a movement and is incremented every frame when the following conditions are met: the magnitude of motion exceeds a threshold, and the angle of motion is roughly opposite to the last update.

The system 158 uses a previous angle image that updates the angle image with the optical flow angle at the pixel where the corresponding accumulator image pixel is updated, and a motion history image, which tracks recency of motion. The motion history image pixel is set to zero at the pixel where the corresponding accumulator image pixel is updated. For all other pixels that are not reset, the system 158 increments the count. If the count reaches a previously defined threshold (e.g., a function of time), the corresponding accumulator pixels and the motion history image are reset to zero, as the motion is not recent.

### Examples of Repetition Counting Using Self Similarity of Images

In some embodiments, the system 158 may utilize the repetitiveness of a sequence of images when performing repetition counting. First, the system 158 may set a reference frame (e.g., a starting frame for a movement or exercise). Next, the system 158 generates an embedding for the reference frame (e.g., using DeepMatch, as described herein).

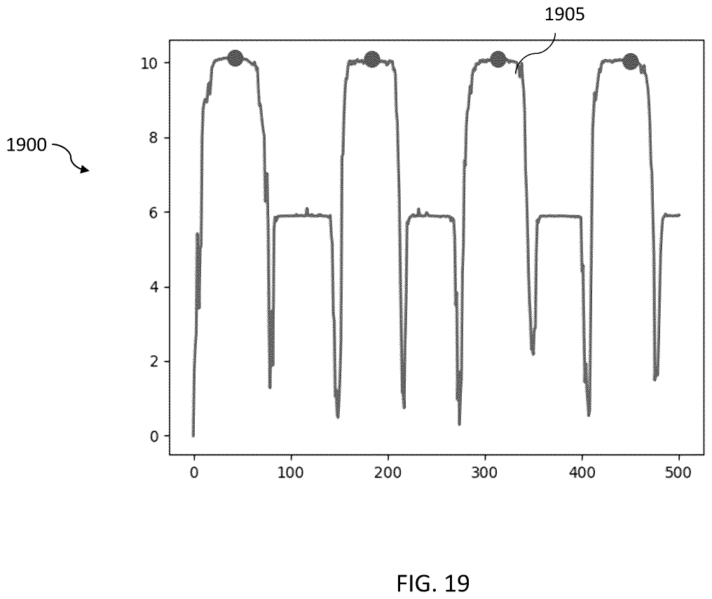

For each subsequent frame, the system 158 calculates the embeddings for the frames to determine an L2 distance between each frame and the embedding of the reference frame. The system 158 may then use the signal (e.g., the L2 distance) for repetition counting. FIG. 19 depicts a graph 1900 that presents an example signal 1905 for a front lunge movement (where the peaks are detected using autocorrelation on a smoothed signal).

Such an approach may assume that an exercise is visually repetitive and thus capture the repetitiveness in the form of a signal that is processed to count the number of times the repetition has occurred. Regardless of the chosen start frame, the signal may reflect a repetitive pattern due to the inherently repetitive nature of exercises (usually done in reps of 8-12).

The system 158 may select a reference frame in several ways. For example, the system 158 may use a classified DeepMatch pose (which will indicate the start or the end of an exercise sequence) or DeepMatch State Machine updates, as described herein. Class plan information may narrow down the selection process. The system 158, in some cases, may change or dynamically update the reference frame during an exercise (e.g., the system 158 may use different reference frames during a class).

Examples of Validating Peak Quality within Images

In some embodiments, the system 158 can validate peak quality by comparing reference embeddings of expected poses of an exercise. For example, many different techniques described herein (e.g., the inflection point detector, ESPRIT, keypoints, optical flow, and so on) are used to generate an oscillatory signal with peaks and valleys. However, for the different detectors, false peaks may be generated for a variety of reasons: inaccuracy in one of the above detectors itself, inaccuracies in the person detector, self-occluding body parts appearing and disappearing, a user not following the instructor and/or resting, and so on.

Thus, in some cases, when a peak is identified in real-time, since this is an inflection point where the motion is zero and is reversing, the system 158 may use the DeepMatch embeddings generated from the network and compare them to a reference set. In some cases, the embeddings may correspond to expected poses that are used in DeepMatch. Such poses can also be seen from the RepNet, where similar embeddings across different periods in the video show similar states, and therefore can be compared to a reference set that represents that state (e.g., in such a case when a user is in full expression of a pose before going into motion again).

In some cases, the system 158 compares the embedding distances against the reference set and generates a quality metric (e.g., taking the average of matches across the entire reference set or the best match across the reference set). A reference set typically has many frames from different videos to allow for member orientation variance, among other things.

### Examples of Detecting Weights During Repetition Counting

As described herein, the repetition counting system 158 may count repetitions during strength or lifting activities, such as activities where a user is holding and lifting weights (e.g., dumbbells, barbells, and so on). In some embodiments, the system 158 utilizes computer vision techniques to detect the weights (e.g., dumbbells) held by a user during an exercise.

For example, the system 158 may utilize a deep learning-based approach that modifies the SSD used for person detection to include additional classes that directly predict the dumbbells in the frame. The cross section of the weight prediction with wrist keypoints is taken, and if the intersection over union of this cross section is greater than a specific threshold, a weight for the given left/right wrist is activated.

As another example, the system 158 utilizes a classical CV approach that uses keypoints produced by a blazepose architecture and the HSV color values of the weights. Once the keypoints of the wrists are identified, a crop of 25×25 pixels is taken around the user's hand. The crop is then masked, where all pixels which are not in the given HSV range for a certain color dumbbell are set to 0. When the sum of the pixels that are not masked is greater than a given threshold, the weight is detected/activated for a particular hand. Such an approach may identify each dumbbell in an image and associate the identified dumbbell with a given wrist (left/right) for volume specific rep counting or other actions.

### Examples of Repetition Counting Enhancements

In various embodiments, the repetition counting system 158 can perform various processes or techniques when performing repetition counting during an exercise performed by a user.

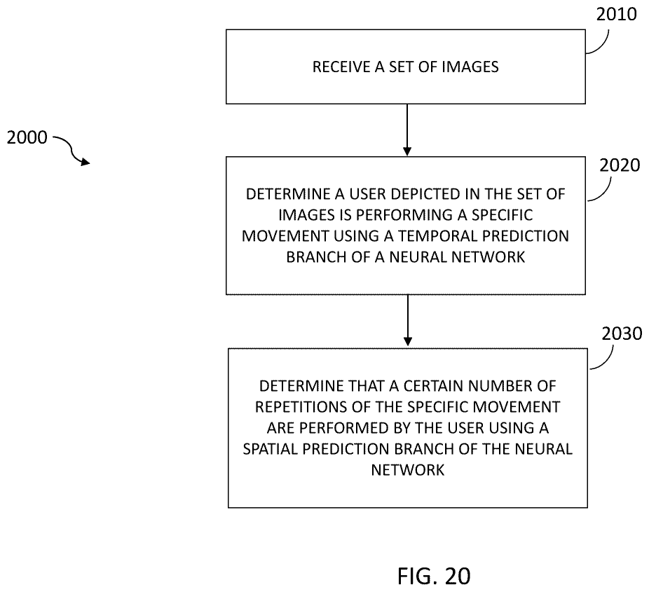

FIG. 20 is a flow diagram illustrating an example method 2000 for counting repetitions of an exercise performed by a user. The method 2000 may be performed by the repetition counting system 158 and, accordingly, is described herein merely by way of reference thereto. It will be appreciated that the method 2000 may be performed on any suitable hardware or by the various systems described herein.

In operation 2010, the system 158 receives a set of images. For example, the system 158 may capture, receive, or access the set of images 210 (e.g., a sequence of frames of a video stream) of a user performing a movement of an exercise activity.

In operation 2020, the system 158 determines a user depicted in the set of images is performing a specific movement using a temporal prediction branch of a multi-task machine learning prediction model. For example, the system 158 can employ a follow along prediction head that employs a temporal shift module to determine the specific movement.

In operation 2030, the system 158 determines that a certain number of repetitions of the specific movement are performed by the user using a spatial prediction branch of the multi-task machine learning prediction model. For example, the system 158 can employ a repetition counting prediction head (specific for the movement) that employs an inflection detection module to determine each repetition of the specific movement is performed by the user.

In some cases, the spatial prediction branch includes a repetition counting prediction head that determines a repetition of the specific movement is performed by the user by generating a softmax probability of a number of repetitions of the specific movement performed by the user, outputting the softmax probability to a state machine; and, when the state machine changes state to a target state, determining the user has performed a repetition of the specific movement.

In some cases, the system 158 may determine that an orientation of the user with respect to a camera that captured the set of images is a correct orientation using the spatial prediction branch of the multi-task machine learning prediction model.

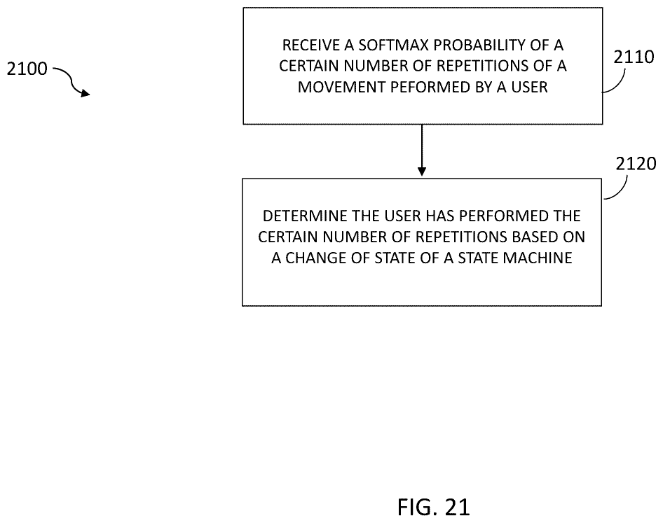

FIG. 21 is a flow diagram illustrating an example method 2100 for determining a repetition count of a movement performed by a user. The method 2100 may be performed by the repetition counting system 158 and, accordingly, is described herein merely by way of reference thereto. It will be appreciated that the method 2100 may be performed on any suitable hardware or by the various systems described herein.

In operation 2110, the system 158 receives, at a state machine and from a prediction head within a neural network, a softmax probability of a certain number of repetitions of a movement performed by a user based on a set of images captured of the user performing the movement. In some cases, the softmax probability is based on a prediction determined by a prediction head within the neural network.

In operation 2120, the system 158 determines the user has performed the certain number of repetitions of the movement based on a change of state of the state machine. For example, the state machine 1600 may receive a softmax probability and change to a “target” state, causing an output to increment a repetition counter for the user during the exercise or movement.

### Examples of Repetition Counting for Interval-Based Segments

As described herein, the repetition counting system 158 may perform the various techniques described herein when counting or tracking repetitions during interval-based segments, such as EMOM or AMRAP segments, of a workout activity. Because such segments may be time-based (e.g., an EMOM segment may be broken up into one-minute rounds), the system 158 may integrate the tracking of repetitions and a timeline of the workout activity in order to effectively progress the activity from one segment, or sub-segment, to a subsequent segment, or sub-segment.

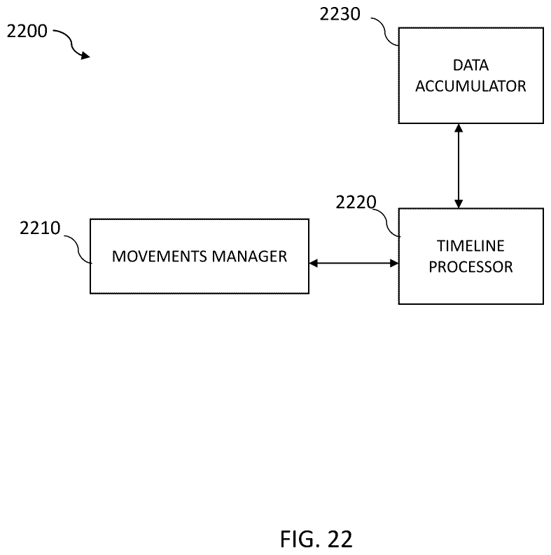

FIG. 22 is a diagram illustrating components of a repetition counting system 2200 (e.g., the system 158), adapted to count repetitions of movements performed during interval-based segments. The system 2200 may include a movements manager 2210, a time processor 2220, and a data accumulator 2230.

In some embodiments, the timeline processor 2220 tracks the status of movements performed by the user during a segment. The timeline processor 2220 receives information from the movements manager 2210, which may utilize the techniques described herein to determine that a user is performing expected or identified movements during an exercise class (e.g., cued by an instructor during a streaming class or workout).

The timeline processor 2220 may receive a map or mapping of movements, segments, and/or sub-segments. Each movement may be associated with metadata, such as a sub-segment ID, a movement ID, a mapping ID, a name, a rep or target, and so on. Further, the metadata may include rest information (e.g., time between movements), such as a sub-segment ID, a movement length/offset, a name, and so on. The map may also include information for a current or tracked interval (e.g., an AMRAP or EMOM) that includes the movement. The metadata may include information for the interval, such as a sub-segment ID, a round number, an active movement (or associated movements), a rep target, an associated muscle or body part, and so on.

Using the mapped information, the timeline processor 2220 may communicate with the data accumulator, which tracks the repetitions performed by the user for the movement or interval and stores sub-segment data for each interval (e.g., for each movement or round of the interval).

The system 2200 may then perform actions using the sub-segment data, such as actions that prompt or progress the user from one segment to the next segment in an exercise class, actions that credit or reward the user with a completed interval, round, segment, sub-segment, and so on, actions that display the progress of the user during a current interval, round, segment, sub-segment, and so on, actions that update a body activity database, and so on.

As described herein, for tracking and score visualization, the system 2200, via the timeline processor 2220, utilizes a timing system (e.g., a clock mechanism) that polls a video position (e.g., a position in time of an exercise class) frequently (e.g., every second) to maintain the exercise class, associated AI/ML system, and/or user movement credit (e.g., via the data accumulator 2230) in synchronization. The timeline processor 2220, therefore, enables the system 2200 to control the flow of data and assign credit to users when successful movements are performed during interval-based segments.

To support repetition counting within rounds (or other sub-segments) utilized by AMRAP and EMOM workouts, the system 2200 may utilize the timeline processor 220 or similar mechanism. In some cases, the system 2200 calls the timeline processor 2220 (e.g., every second) while a class experience progresses through time. For example, when there is an AMRAP segment, the timeline processor 2220 may retrieve an “active” movement out of a list of expected movements (e.g., specific to the class or associated with all classes of the platform, such as described with respect to the movement database) from the movements manager 2210, and track how many rounds occurred during the class.

The timeline processor 2220 may update the underlying data (e.g., via the data accumulator 2230) when a position in time within a running/streaming class causes the sub-segment to change (e.g., instead of on a per second basis). Thus, the system 2200 tracks metadata related to the interval-based sub-segments and uses the metadata to perform actions. For example, the data accumulator 2230 may be drive a status of an active movement by indicating to the timeline processor 2220 that goals (e.g., repetition targets within an interval) have been reached. The timeline processor 2220, using the data, may then increment to a next or subsequent movement. The following is an example, sub-segment mapping type used by the timeline processor 2220:

```
sealed class ActiveSubsegmentType {
  data class Movement(
    val subsegmentId: String,
    val displayName: String,
    val offset: Int,
    val length: Int,
    val movement: TimelineMovement
  ) : ActiveSubsegmentType( )
  data class Amrap(
    val subsegmentId: String,
    val displayName: String,
    val offset: Int,
    val length: Int,
    val roundNumber: Int = 0,
    val activeMovementPosition: Int = 0,
    val movements: List<TimelineMovement>
  ) : ActiveSubsegmentType( ) {
    fun getActiveMovement( ): TimelineMovement {
      return this.movements[activeMovementPosition]
    }
    fun incrementActiveMovement( ): ActiveSubsegmentType {
      return if (activeMovementPosition == movements.lastIndex) {
        copy(
          activeMovementPosition = 0,
          roundNumber = roundNumber + 1
        )
      } else {
        copy(
          activeMovementPosition = activeMovementPosition + 1
        )
      }
    }
  }
}
```

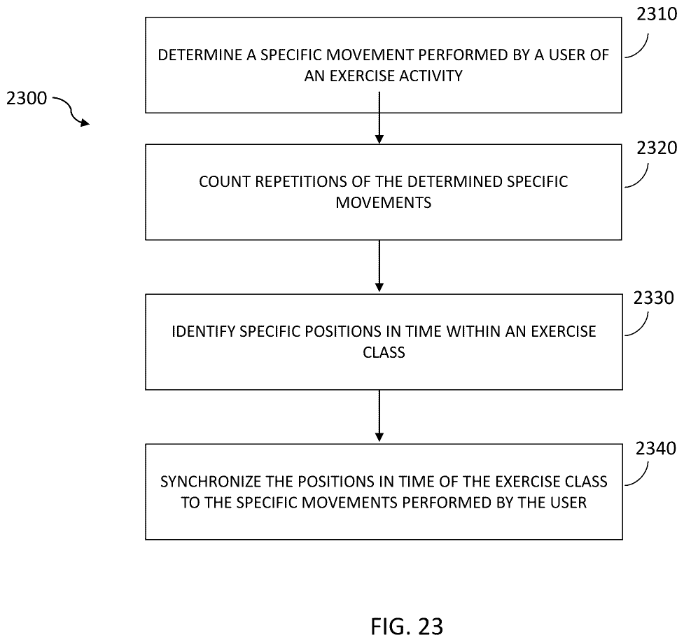

As described herein, the repetition counting system 158 or system 2200 may perform various techniques described herein to count repetitions during interval-based workouts, and cause exercise classes to progress between segments (or sub-segments) in response to users achieving repetition or workout goals. FIG. 23 is a flow diagram illustrating an example method 2300 for counting repetitions of an interval-based segment of an exercise class performed by a user. The method 2300 may be performed by the repetition counting system 158 or system 2200 and, accordingly, is described herein merely by way of reference thereto. It will be appreciated that the method 2300 may be performed on any suitable hardware or by the various systems described herein.

In operation 2310, the repetition counting system 158 determines specific movements performed by a user of an exercise activity based on sets of images captured of the user performing the exercise activity. For example, the movements manager 2210 may utilize one or more techniques described herein to determine the user is performing a specific movement during an exercise activity (e.g., a bicep curl during a lifting class).

In operation 2320, the repetition counting system 158 counts repetitions of the determined specific movements performed by the user of the exercise activity based on the sets of images captured of the user performing the exercise activity. For example, the movements manager 2210 may utilize one or more techniques described herein to determine the user has performed a certain number of repetitions of the movement (e.g., the user has performed 10 bicep curls).

In operation 2330, the repetition counting system 158 identifies specific positions in time within an exercise class presented to the user during the exercise activity. For example, the timeline processor 2220 receives information that maps the movement performed by the user to a sub-segment within a running exercise class.

In operation 2340, the repetition counting system 158 synchronizes the identified specific positions in time within the exercise class to the determined specific movements performed by the user of the exercise activity. For example, the timeline processor 2220 aligns the movement performed by the user to time positions within the exercise class.

Thus, the system 158 can track a user, in synchronization, during an interval-based segment, and determine both (1) the user has performed a certain number of an expected movement, and (2) the exercise class has progress to a certain position in time (e.g., one minute. The system 158 may then perform actions, as described herein, based on the determinations that the user has performed the certain number of movements and/or the class has progressed through a certain duration or round.

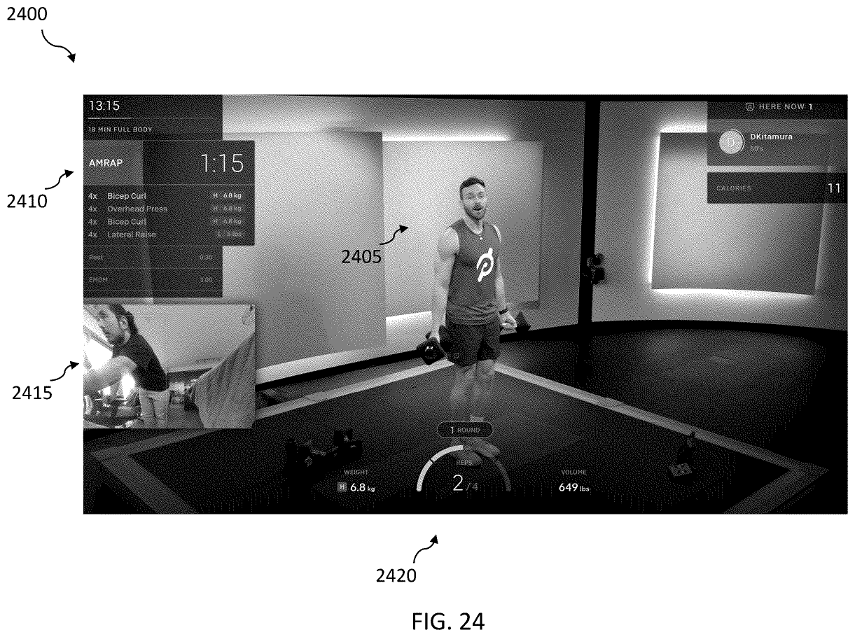

For example, the system 158 may present a UI that displays a current interval-based segment of an exercise class and the repetitions counted for a user performing an exercise activity. FIG. 24 is a diagram illustrating an example user interface 2400 displayed during an interval-based exercise class.

The UI 2400 may present an interval-based exercise class (e.g., an AMRAP) led by an instructor 2405. The UI 2400 includes movement information 2410 for the AMRAP, identifying the different movements (e.g., “4× bicep curl,” “4× overhead press,” “4× bicep curl,” “4× lateral raise”).

The UI 2400 may also display an image 2415 of a user performing the movements, and a tracker 2420 that displays the repetitions performed by the user. As shown, the tracker 2420 may display the round of the class, the number of counted repetitions, the current weight for the movement, the total weight lifted, and so on. Thus, the UI 2400 may update, as described herein, with information that display the progress of the user as the user moves through repetitions/rounds/segments, and so on. Thus, the technology can present the user with UIs that facilitate the presentation of information related to rep counting, as well as display elements that enhance the presentation of content and assist the user during performance and/or exercise activities.

For example, the repetition counting system 158 and/or 2200 may track and/or display the following information or metrics, such as (1) in-class metrics (e.g., repetition counting or tracking, weight tracking, volume tracking, streak tracking, time tracking (e.g., time performing a movement), weight adjustments, and so on), (2) post-class metrics (targets or goals achieved, total performed reps, sets, volume, movement statistics, and so on).

### Example Embodiments of the Technology

Thus, a repetition counting system may implement various repetition counting techniques with timing systems, as described herein, to track and count repetitions performed during interval-based classes.

The system, in some embodiments, may include: a neural network, including a temporal prediction branch having a follow along prediction head that employs a temporal shift module to determine specific movements performed by a user of an exercise activity based on sets of images captured of the user performing the exercise activity, and a spatial prediction branch having a repetition counting prediction head that employs an inflection detection module to count repetitions of the determined specific movements performed by the user of the exercise activity based on the sets of images captured of the user performing the exercise activity, and a timing system that is configured to identify specific positions in time within an exercise class presented to the user during the exercise activity, and synchronize the identified specific positions in time within the exercise class to the determined specific movements performed by the user of the exercise activity.

In some embodiments, the system may include a processor and one or more memories coupled to the processor, wherein the processor is configured to receive a set of images associated with an exercise activity performed by a user, determine the user depicted in the set of images is performing a specific movement of the exercise activity using a temporal prediction branch of a multi-task machine learning prediction model, and determine that an interval of multiple instances of the specific movement is performed by the user using a spatial prediction branch of the multi-task machine learning prediction model.

In some embodiments, the repetition counting system may receive, at a state machine and from a prediction head of a neural network, a softmax probability of an interval of multiple instances of a specific movement performed by a user based on a set of images captured of the user performing the movement, and determine the user has performed the interval of multiple instances of the specific movement based on a change of state of the state machine.

In some embodiments, the repetition counting system utilizes other techniques (e.g., keypoint detection), as described herein, when tracking movements and performing actions during interval-based classes or segments.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A repetition counting system, comprising:
a neural network, including:
a temporal prediction branch having a follow along prediction head that employs a temporal shift module to determine specific movements performed by a user of an exercise activity based on sets of images captured of the user performing the exercise activity; and
a spatial prediction branch having a repetition counting prediction head that employs an inflection detection module to count repetitions of the determined specific movements performed by the user of the exercise activity based on the sets of images captured of the user performing the exercise activity; and
a timing system that is configured to:
identify specific positions in time within an exercise class presented to the user during the exercise activity; and
synchronize the identified specific positions in time within the exercise class to the determined specific movements performed by the user of the exercise activity.

2. The repetition counting system of claim 1, further comprising:
an action module that performs an action associated with the exercise class in response to receiving a prompt from the timing system.

3. The repetition counting system of claim 2, wherein the action module causes the exercise class to progress to a next movement within the exercise class to be performed by the user.

4. The repetition counting system of claim 2, wherein the action module causes a display associated with the exercise class to present a count of the movements performed by the user of the exercise activity.

5. The repetition counting system of claim 2, wherein the action module causes a repetition tracker associated with the exercise class to credit the user with completing a segment of the exercise class.

6. The repetition counting system of claim 1, wherein the timing system includes a clock mechanism that polls positions within video of the exercise class to synchronize the identified specific positions in time within the exercise class to the determined specific movements performed by the user.

7. The repetition counting system of claim 1, wherein the timing system includes a timeline processor that causes the exercise class to move from a current segment to a subsequent segment based on a number of determined specific movements performed by the user of the exercise activity.

8. The repetition counting system of claim 7, wherein the current segment and the subsequent segment are segments within an every minute on the minute (EMOM) portion of the exercise class.

9. The repetition counting system of claim 7, wherein the current segment and the subsequent segment are segments within an as many repetitions as possible (AMRAP) portion of the exercise class.

10. The repetition counting system of claim 1, wherein the neural network includes a multi-task machine learning prediction model that includes fully connected layers that contain prediction heads that generate predictions for counting repetitions of a specific movement performed by a user of an exercise activity based on a set of images captured of the user performing the exercise activity.

11. A repetition counting system, comprising:
a processor;
one or more memories coupled to the processor, wherein the processor is configured to:
receive a set of images associated with an exercise activity performed by a user;
determine the user depicted in the set of images is performing a specific movement of the exercise activity using a temporal prediction branch of a multi-task machine learning prediction model; and
determine that an interval of multiple instances of the specific movement is performed by the user using a spatial prediction branch of the multi-task machine learning prediction model.

12. The repetition counting system of claim 11, wherein the interval of multiple instances of the specific movement includes a certain number of repetitions of the specific movement.

13. The repetition counting system of claim 11, wherein the interval of multiple instances of the specific movement is an every minute on the minute (EMOM) interval within an exercise class being performed by the user.

14. The repetition counting system of claim 11, wherein the interval of multiple instances of the specific movement is an as many repetitions as possible (AMRAP) interval within an exercise class being performed by the user.

15. The repetition counting system of claim 11, wherein the processor is further configured to:
identify specific positions in time within an exercise class presented to the user during the exercise activity; and
synchronize the identified specific positions in time within the exercise class to the interval of multiple instances of the specific movement performed by the user of the exercise activity.

16. A non-transitory, computer-readable medium whose contents, when executed by a repetition counting system, causes the repetition counting system to perform a method, the method comprising:
receive, at a state machine and from a prediction head of a neural network, a softmax probability of an interval of multiple instances of a specific movement performed by a user based on a set of images captured of the user performing the movement; and
determine the user has performed the interval of multiple instances of the specific movement based on a change of state of the state machine.

17. The non-transitory, computer-readable medium of claim 16, wherein the neural network is a DeepMove neural network.

18. The non-transitory, computer-readable medium of claim 16, wherein the softmax probability is based on a prediction determined by the prediction head of the neural network.

19. The non-transitory, computer-readable medium of claim 16, wherein the prediction head is specific to the specific movement.

20. The non-transitory, computer-readable medium of claim 16, wherein the interval of multiple instances of the specific movement is an every minute on the minute (EMOM) interval within an exercise class being performed by the user or an as many repetitions as possible (AMRAP) interval within an exercise class being performed by the user.
